(19) United States
(12) Patent Application Publication
(10) Pub. No.: US 2013/0282672 A1
(43) Pub. Date: Oct. 24, 2013

(54) STORAGE APPARATUS AND STORAGE CONTROL METHOD

(71) Applicants: Naomitsu Tashiro, Oi (JP); Mikito Ogata, Odawara (JP)

(72) Inventors: Naomitsu Tashiro, Oi (JP); Mikito Ogata, Odawara (JP)

(73) Assignees: HITACHI COMPUTER PERIPHERALS CO., LTD., KANAGAWA-KEN (JP); HITACHI, LTD., TOKYO (JP)

(21) Appl. No.: 13/516,961

(22) PCT Filed: Apr. 18, 2012
(86) PCT No.: PCT/JP12/60504

§ 371 Date: Jun. 18, 2012

(51) Int. Cl. G06F 17/30

(52) U.S. Cl. 707/692; 707/E17.002

(57) ABSTRACT

The present invention not only reduces the load but also enhances the accuracy of de-duplication in a storage apparatus which performs in-line de-duplication processing and post-process de-duplication processing. A storage apparatus comprises a storage device and a controller. The controller receives multiple files, and by performing in-line de-duplication processing under a prescribed condition, detects from among the multiple files a file which is duplicated with a file received in the past, stores in the temporary storage area a file other than the detected file of the multiple files, and partitions the stored file into multiple chunks, and by performing post-process de-duplication processing, detects from among the multiple chunks a chunk which is duplicated with a chunk received in the past, and stores in the transfer-destination storage area a chunk other than the detected chunk of the multiple chunks.

### TECHNICAL FIELD

The present invention relates to technology for the de-duplication of data inputted to a storage.

### BACKGROUND ART

Software-based de-duplication and compression identify duplication prior to writing data to a HDD (hard disk drive) or other such backup media, and as such, place a load on the CPU (central processing unit). Thus, when data stream multiplicity increases in In-line de-duplication, which performs on-the-fly writing of data, the increase in the CPU load is pronounced.

In Post-process de-duplication, when an ingest side process is put on standby to inhibit overrun due to an ingest buffer put pointer overtaking a get pointer, this leads to an immediate drop in either backup performance or restoration performance. Therefore, ingest buffer capacity must be increased.

The main purpose of introducing a deduplicated storage is to hold down on backup capacity and lower backup-related costs. When an attempt is made to improve ingest performance (either backup performance or restoration performance) by using a high-performance HDD and a RAID (Redundant Arrays of Inexpensive Disks, or Redundant Arrays of Independent Disks), costs go up. It is not possible to apply de-duplication to a combination of storage media with different performances and costs. The cost of storage capacity design and capacity configuration management is high.

Technology for executing post-process de-duplication in addition to in-line de-duplication, and technology for initially performing de-duplication processing at the block level, and performing de-duplication processing at the content level only for the remaining content are known (for example, Patent Literature 1 and 2).

### CITATION LIST

### Patent Literature

### [PTL 1]

US Patent Application Publication No. 2011/0289281

### [PTL 2]

WO 2010/100733

### SUMMARY OF INVENTION

### Technical Problem

However, in the technology for executing post-process de-duplication in addition to in-line de-duplication, the processing method for the in-line de-duplication process and the processing method for the post-process de-duplication process are the same in the storage apparatus. In accordance with this, there may be cases where the access performance of a computer, which accesses the storage apparatus, drops as a result of the in-line de-duplication process. Conversely, there may be cases where de-duplication cannot be adequately performed in accordance with the post-process de-duplication process.

Also, in the technology for initially performing de-duplication processing at the block level and then performing de-duplication processing at the content level only for the remaining content, the problem is that when de-duplication processing is performed at the content level after executing de-duplication processing at the block level, which is smaller than the content, the need for detailed comparisons in the block-level de-duplication processing increases the load.

### Solution to Problem

To solve for the above problems, a storage apparatus which is one mode of the present invention, comprises a storage device which comprises a temporary storage area and a transfer-destination storage area, and a controller which is coupled to the storage device. The controller receives multiple files, and in accordance with performing in-line de-duplication processing under a prescribed condition, detects from among the multiple files a file which is duplicated with a file received in the past, stores a file other than the detected file from among the multiple files in the temporary storage area, and partitions the stored file into multiple chunks, and in accordance with performing post-process de-duplication processing, detects from among the multiple chunks a chunk which is duplicated with a chunk received in the past, and stores a chunk other than the detected chunks from among the multiple chunks in the transfer-destination storage area.

### Advantageous Effects of Invention

According to one mode of the present invention, it is possible to both reduce the load on the storage apparatus, which performs in-line de-duplication processing and post-process de-duplication processing, and to enhance de-duplication accuracy.

### BRIEF DESCRIPTION OF DRAWINGS

FIG. 1 shows the configuration of a storage apparatus.

FIG. 2 shows a hardware configuration for each of a storage apparatus 100, a storage apparatus 200, and a backup server 300.

FIG. 3 shows the hardware configuration of a management computer 400.

FIG. 4 shows the software configuration of the storage apparatus 200.

FIG. 5 shows the software configuration of the storage apparatus 100.

FIG. 6 shows the software configuration of the backup server 300.

FIG. 7 shows the software configuration of the management computer 400.

FIG. 8 schematically shows a first-generation backup.

FIG. 9 schematically shows a second-generation backup.

FIG. 10 shows a file pointer table 2520.

FIG. 11 shows a FP table for coarse-grained determination 2530.

FIG. 12 shows a key-value store operation.

FIG. 13 shows a named array operation.

FIG. 14 shows a chunk pointer table 2540 operation.

FIG. 15 shows a fine-grained de-duplication management table 2550.

FIG. 16 shows the arrangement of compression data 820 in a backup destination.

FIG. 17 shows a status management table 2560.

FIG. 18 shows an inhibit threshold table 2570.

FIG. 19 shows a first backup control process.

FIG. 20 shows a second backup control process.

FIG. 21 shows an inhibit threshold control process.

FIG. 22 shows a coarse-grained de-duplication process.

FIG. 23 shows an association process.

FIG. 24 shows a schedule management process.

FIG. 25 shows a fine-grained de-duplication process.

FIG. 26 shows a chunk determination process.

FIG. 27 shows a restore control process.

### DESCRIPTION OF EMBODIMENTS

A number of examples will be explained. The technical scope of the present invention is not limited to the respective examples.

In the following explanation, various types of information may be explained using the expression “*** table”, but the various information may also be expressed using a data structure other than a table. To show that the various information is not dependent on the data structure, “*** table” can be called “*** information”.

Also, in the following explanation, there may be cases where processing is explained having a “program” as the doer of the action, but since the stipulated processing is performed in accordance with a program being executed by a processor (for example, a CPU (Central Processing Unit)) while using a storage resource (for example, a memory) and a communication control device (for example, a communication port) as needed, the processor may also be used as the doer of the processing. A process, which is explained using a program as the doer of the action, may be regarded as a process performed by a controller. Furthermore, either part or all of a program may be realized using dedicated hardware. Thus, a process, which is explained using a program as the doer of the action, may be a controller-performed process. The controller may comprise a processor and a storage resource for storing a computer program to be executed by the processor, and may comprise the above-mentioned dedicated hardware. A computer program may be installed in respective computers from a program source. The program source, for example, may be either a program delivery server or a storage medium.

In the following explanation, a management system is one or more computers, for example, management computers, or a combination of a management computer and a display computer. Specifically, for example, in a case where the management computer displays display information, the management computer is a management system. Furthermore, for example, the same functions as those of the management computer may be realized using multiple computers to increase processing speed and enhance reliability, and in this case, the relevant multiple computers (may include a display computer in a case where a display computer performs a display) are the management system.

### Example 1

A storage system, which is an applicable example of the present invention, will be explained below.

The storage system of the example performs in-line de-duplication processing in units of files under a prescribed condition. Next, the storage system partitions a file, for which duplication could not be eliminated using the in-line de-duplication processing, into chunks, which are smaller than the file. Next, the storage system performs post-process de-duplication processing in units of chunks.

In accordance with the in-line de-duplication processing performing de-duplication in file units, it is possible to prevent a drop in access performance of a host computer, which is accessing the storage system. Also, the post-process de-duplication processing performs more detailed data comparisons, thereby enabling de-duplication to be performed adequately. In addition, since a file, which has been eliminated using the in-line de-duplication process is not targeted by the post-process de-duplication process, the load of the post-process de-duplication processing can be lowered.

### Configuration of Storage System 10

The configuration of the storage system 10 will be explained below.

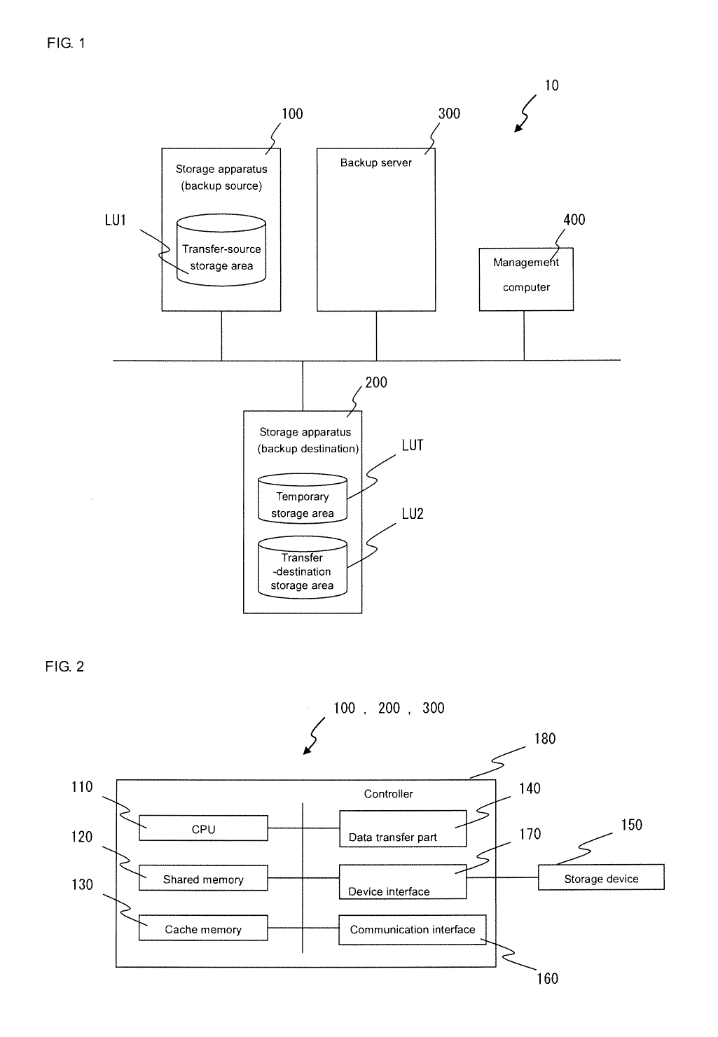

FIG. 1 shows the configuration of the storage system 10. This storage system 10 comprises a storage apparatus 100, a storage apparatus 200, a backup server 300, and a management computer 400. The storage apparatus 100, the storage apparatus 200, the backup server 300, and the management computer 400 are coupled together via a communication network 500 such as a SAN (Storage Area Network) or a LAN (Local Area Network).

The storage apparatus 100 provides a LU1, which is a LU (Logical Unit) of a transfer-source storage area (a backup source). The LU1 stores file, which will become a copy source in a backup. The storage apparatus 200 provides a LUT, which is a temporary storage area LU, and a LU2, which is the LU of a transfer-destination storage area (a backup destination). The LUT stores a post-coarse-grained de-duplication process file. The LU2 stores compressed data and meta information for a post-fine-grained de-duplication process chunk. The backup server 300 issues an instruction for a backup from the storage apparatus 100 to the storage apparatus 200. The management computer 400 boots up and manages the storage system 10.

FIG. 2 shows the respective hardware configurations of the storage apparatus 100, the storage apparatus 200, and the backup server 300. The storage apparatus 100, the storage apparatus 200, and the backup server 300 each comprise a controller 180 and a storage device 150. The controller 180 comprises a CPU 110, a shared memory 120, a cache memory 130, a data transfer part 140, a communication interface 160, and a device interface 170. The storage device 150 stores a program and data. The device interface 170 is coupled to the storage device 150. The communication interface 160 is coupled to the communication network 500. The data transfer part 140 transfers data to and from another apparatus by way of the communication interface 160 and the communication network 500. The CPU 110 reads the program and data inside the storage device 150 to the shared memory 120, and controls the data transfer part 140 and the storage device 150 in accordance with the read program and data.

The storage device 150 in the example is a HDD (hard disk drive), but may be a storage medium such as a nonvolatile semiconductor memory or a magnetic tape. The storage device 150 may comprise a single storage medium, or may comprise multiple storage media. The LU1 is configured using the storage device 150 of the storage apparatus 100. The LUT and the LU2 are configured using the storage device 150 of the storage apparatus 200. Furthermore, the LUT and the LU2 may be configured from respectively different storage media, or may be configured from the same storage medium. The LU1, the LUT, and the LU2 may each be configured from a virtual storage device for using RAID and Thin Provisioning.

The cache memory 130 temporarily stores data, which has been received from an external apparatus, and data, which is to be sent to an external apparatus. The cache memory 130, for example, is a higher-speed memory than the shared memory 120.

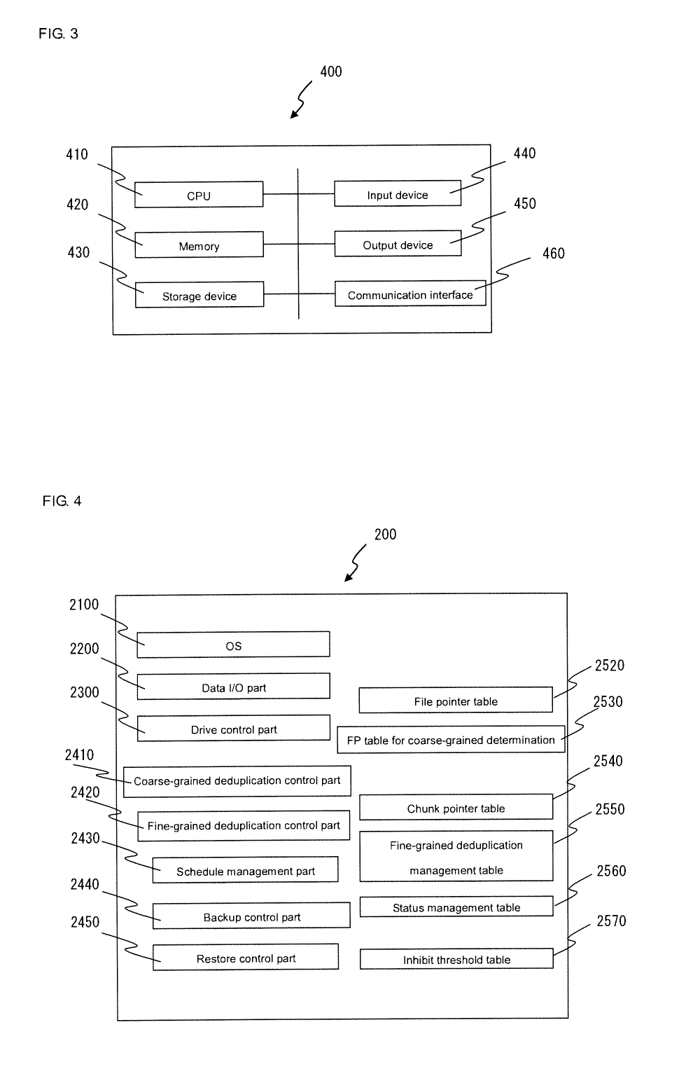

FIG. 3 shows the hardware configuration of the management computer 400. The management computer 400 comprises a CPU 410, a memory 420, a storage device 430, an input device 440, an output device 450, and a communication interface 460. The storage device 430 stores a program and data. The communication interface 460 is coupled to the communication network 500. The CPU 410 reads the program and data inside the storage device 430 to the memory 420, and controls the storage device 430, the input device 440, and the output device 450 in accordance with the read program and data. The input device 440 sends data inputted from a management computer 400 user to the CPU 410. The output device 450 outputs data from the CPU 410 to the user.

FIG. 4 shows the software configuration of the storage apparatus 200. The backup-destination storage apparatus 200 comprises an OS (operating system) 2100, a data I/O (input/output) part 2200, a drive control part 2300, a coarse-grained de-duplication control part 2410, a fine-grained de-duplication control part 2420, a schedule management part 2430, a backup control part 2440, a restore control part 2450, a file pointer table 2520, an FP (finger print) table for coarse-grained determination 2530, a chunk pointer table 2540, a fine-grained de-duplication management table 2550, a status management table 2560, and an inhibit threshold table 2570.

The OS 2100 manages the storage apparatus 200. The data I/O part 2200 manages the input/output of data to/from the storage apparatus 200. The drive control part 2300 controls the storage device 150 inside the storage apparatus 200.

The coarse-grained de-duplication control part 2410 performs coarse-grained de-duplication processing, which is in-line de-duplication processing. Coarse-grained de-duplication processing is de-duplication processing in units of files. The fine-grained de-duplication control part 2420 performs fine-grained de-duplication processing, which is post-process de-duplication processing. Fine-grained de-duplication processing is de-duplication processing in units of chunks. The schedule management part 2430 manages a backup schedule. The backup control part 2440 controls a backup in response to an instruction from the backup server 300. The restore control part 2450 performs a restore control process for controlling a restoration in response to a restore instruction. The inhibit threshold control part 2460 performs an inhibit threshold control process for controlling a threshold for inhibiting a coarse-grained de-duplication process.

The FP table for coarse-grained determination 2530, the chunk pointer table 2540, and the fine-grained de-duplication management table 2550 are stored in the LU2. The file pointer table 2520 is stored in the LUT.

The file pointer table 2520 shows the result and location of de-duplication for each file. The FP table for coarse-grained determination 2530 shows an FP value group for each file, which has been deduplicated. The chunk pointer table 2540 shows a file group for each backup, and meta information and a FP value group for each file. The fine-grained de-duplication management table 2550 shows an association between a FP value and a location of the compressed data of a chunk. The status management table 2560 shows the status of each backup. The inhibit threshold table 2570 shows information for inhibiting a coarse-grained de-duplication process.

FIG. 5 shows the software configuration of the storage apparatus 100. The backup-source storage apparatus 100 comprises an OS 1100, a data I/O part 1200, and a drive control part 1300. This information is stored in the shared memory 120.

The OS 1100 manages the storage apparatus 100. The data I/O part 1200 manages the input/output of data to/from the storage apparatus 100. The drive control part 1300 controls the storage device 150 inside the storage apparatus 100.

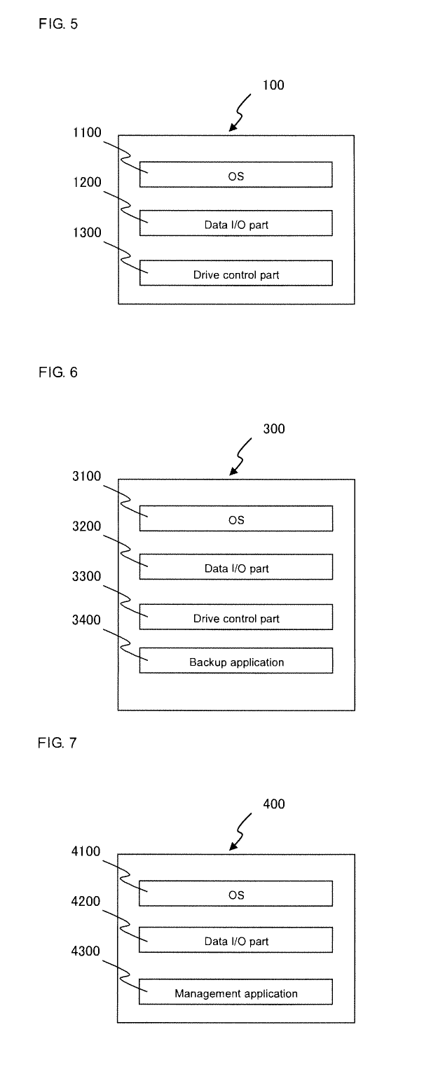

FIG. 6 shows the software configuration of the backup server 300. The backup server 300 comprises an OS 3100, a data I/O part 3200, a drive control part 3300, and a backup application 3400. This information is stored in the shared memory 120.

The OS 3100 manages the backup server 300. The data I/O part 3200 manages the input/output of data to/from the backup server 300. The drive control part 3300 controls the storage device 150 inside the backup server 300. The backup application 3400 instructs either a backup or a restore.

FIG. 7 shows the software configuration of the management computer 400. The management computer 400 comprises an OS 4100, a data I/O part 4200, and a management application 4300.

The OS 4100 manages the management computer 400. The data I/O part 4200 manages the input/output of data to/from the management computer 400. The management application 4300 manages the storage system 10.

### Specific Example of Storage System 10 Backup

A specific example of a backup by the storage system 10 will be explained below.

It is supposed here that the storage system 10 performs a first-generation backup and a second-generation backup.

The first-generation backup will be explained first.

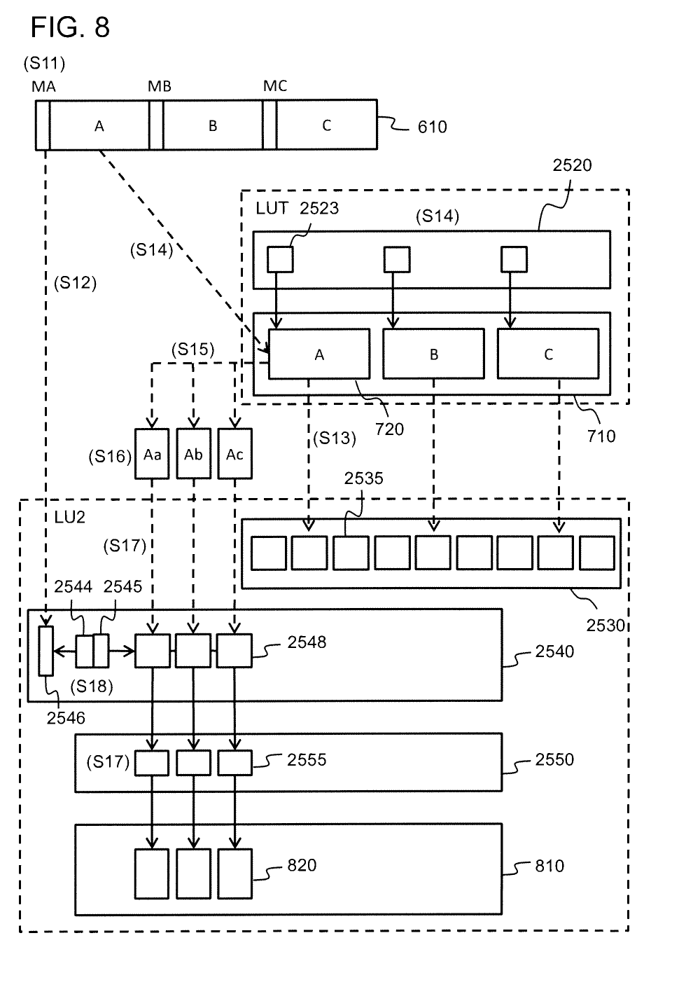

FIG. 8 schematically shows the first-generation backup. Coarse-grained de-duplication processing and fine-grained de-duplication processing are performed during the backup.

The backup application 3400 of the backup server 300 instructs the storage apparatuses 100 and 200 to commence a backup, creates a data stream 610 by reading A, B, and C, which are files 720, from the LU1, and adding MA, MB, and MC, which is meta information 2546, at the head of the A, the B, and the C, and sends the data stream 610 to the storage apparatus 200 via the communication network 500. The meta information 2546 is for managing the backup. In the example, it is supposed that all of the A, the B, and the C are being backed up for the first time, and, in addition, the contents of the files differ from one another. A file may be called a data block.

First, the coarse-grained de-duplication control part 2410 performs coarse-grained de-duplication processing (S11 through S14).

In S11, the coarse-grained de-duplication control part 2410 separates the data stream 610, which was received from the backup server 300 and stored in the cache memory 130, into meta information 2546 and files 720.

Next, in S12, the coarse-grained de-duplication control part 2410 registers the meta information 2546 and a meta pointer 2544, which shows the location of the meta information 2546, in the chunk pointer table 2540 inside the LU2.

Next, in S13, the coarse-grained de-duplication control part 2410 computes the FP (finger print) values 2535 of the chunks inside each file 720, and determines whether or not these FP values 2535 have been registered in the FP table for coarse-grained determination 2530. The coarse-grained de-duplication control part 2410, for example, calculates a FP value 2535 using a hash function. A FP value 2535 may also be called a hash value. In the example, the FP values 2535 of the A, the B, and the C have yet to be registered in the FP table for coarse-grained determination 2530, and as such, the coarse-grained de-duplication control part 2410 registers the FP values 2535 calculated based on the A, the B, and the C in the FP table for coarse-grained determination 2530.

Next, in S14, the coarse-grained de-duplication control part 2410 writes the A, the B, and the C to a file data storage area 710 inside the LUT, and registers a file pointer 2523, which shows the location of each file 720, in the file pointer table 2520 inside the LUT.

Next, the fine-grained de-duplication control part 2420 performs fine-grained de-duplication processing (S15 through S19). The fine-grained de-duplication processing for the A will be explained here, but the fine-grained de-duplication processing is performed the same for the B and the C as for the A.

In S15, in accordance with referencing the file pointer table 2520 inside the LUT, the fine-grained de-duplication control part 2420 recognizes the A, which is the target of the fine-grained de-duplication processing, and reads the A from the LUT.

Next, in S16, the fine-grained de-duplication control part 2420 performs chunking on the A. In accordance with this, it is supposed that the A is partitioned into Aa, Ab, and Ac, which are multiple chunks. That is, the size of a chunk is smaller than the size of a file. A chunk may also be called a segment.

Next, in S17, the fine-grained de-duplication control part 2420 computes a FP value 2548 for each chunk, and determines whether or not the FP values 2548 have been registered in the fine-grained de-duplication management table 2550. A FP value 2548 can also be called a hash value. In the example, the FP values 2548 of the chunks have yet to be registered in the fine-grained de-duplication management table 2550, and as such, the fine-grained de-duplication control part 2420 registers the FP values 2548 of the chunks in the fine-grained de-duplication management table 2550.

Next, in S18, the fine-grained de-duplication control part 2420 writes the compressed data 820 of each chunk to a data storage area 810 inside the LU2, and associates a chunk address 2555, which shows the location of the compressed data 820 of each chunk, with the FP value 2548 in the fine-grained de-duplication management table 2550. In addition, the fine-grained de-duplication control part 2420 registers a chunk list pointer 2545 denoting the location of the FP value 2548 in the chunk pointer table 2540.

The preceding is the first-generation backup.

The second-generation backup will be explained next.

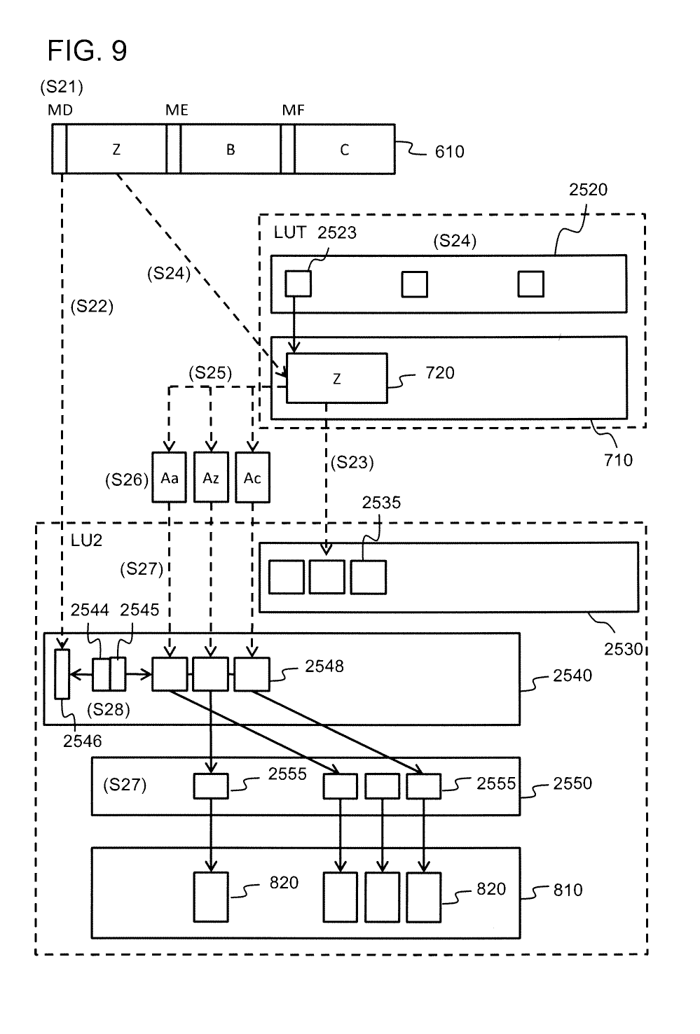

FIG. 9 schematically shows the second-generation backup. The backup application 3400 of the backup server 300 instructs the storage apparatuses 100 and 200 to commence a backup, creates a data stream 610 by reading Z, B, and C, which are files 720, from the LU1, and adding MD, ME, and MF, which is meta information 2546, at the head of the Z, the B, and the C, and sends the data stream 610 to the storage apparatus 200. In the example, it is supposed that the A of the A, the B, and the C described hereinabove has been replaced with the Z, and, in addition, that the Z is a different file from the B and the C.

First, the coarse-grained de-duplication control part 2410 performs coarse-grained de-duplication processing (S21 through S24).

In S21, the coarse-grained de-duplication control part 2410 separates the data stream 610, which was received from the backup server 300 and stored in the cache memory 130, into meta information 2546 and files 720.

Next, in S22, the coarse-grained de-duplication control part 2410 registers the meta information 2546 and the meta pointer 2544, which denotes the location of the meta information, in the chunk pointer table 2540 inside the LU2.

Next, in S23, the coarse-grained de-duplication control part 2410 computes the FP values 2535 of the chunks inside each file 720, and determines whether or not these FP values 2535 have been registered in the FP table for coarse-grained determination 2530. In the example, only the FP value 2535 of the Z has yet to be registered in the FP table for coarse-grained determination 2530, and as such, the coarse-grained de-duplication control part 2410 registers the FP value 2535 calculated based on the Z in the FP table for coarse-grained determination 2530.

Next, in S24, the coarse-grained de-duplication control part 2410 writes the Z to the file data storage area 710 inside the LUT, and registers a file pointer 2523, which denotes the location of the file 720, in the file pointer table 2520 inside the LUT. In addition, the coarse-grained de-duplication control part 2410 registers the B and the C chunk list pointers 2545, which are in the chunk pointer table 2540 inside the LU2, in the file pointer table 2520.

Next, the fine-grained de-duplication control part 2420 performs fine-grained de-duplication processing (S25 through S29). At this point, the B and the C, as a result of being determined to be redundant by the coarse-grained de-duplication process, are not stored in the LUT and are not targeted for fine-grained de-duplication processing.

In S25, in accordance with referencing the file pointer table 2520 inside the LUT, the fine-grained de-duplication control part 2420 recognizes the Z, which is the target of the fine-grained de-duplication processing, and reads the Z from the LUT.

Next, in S26, the fine-grained de-duplication control part 2420 performs chunking on the Z. In accordance with this, the Z is partitioned into Aa, Az, and Ac, which are multiple chunks. When the A and the Z are compared here, Ab has simply been replaced with Az.

Next, in S27, the fine-grained de-duplication control part 2420 computes a FP value 2548 for each chunk, and determines whether or not the FP values 2548 have been registered in the fine-grained de-duplication management table 2550. In the example, only the FP value 2548 of the Az has yet to be registered in the fine-grained de-duplication management table 2550, and as such, the fine-grained de-duplication control part 2420 registers the FP value 2548 of the Az in the fine-grained de-duplication management table 2550.

Next, in S28, the fine-grained de-duplication control part 2420 writes the compressed data 820 of the Az to the data storage area 810 inside the LU2, and associates the chunk address 2555, which denotes the location of the Az, with the FP value 2548 in the fine-grained de-duplication management table 2550. The fine-grained de-duplication control part 2420 also registers a chunk list pointer 2545 denoting the location of the FP value 2548 in the chunk pointer table 2540.

The preceding is the second-generation backup.

Information Inside Storage Apparatus 200

The information inside the storage apparatus 200 will be explained below.

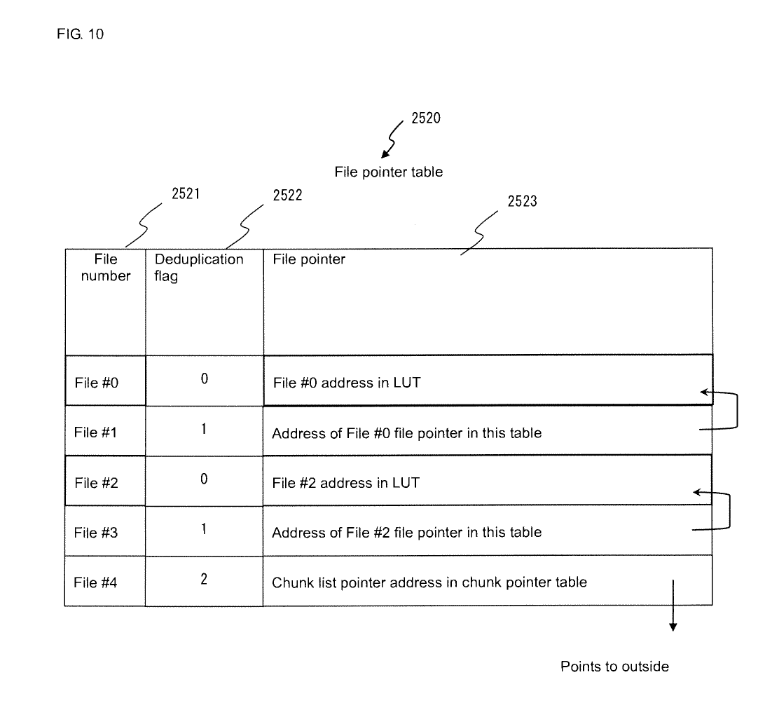

FIG. 10 shows the file pointer table 2520. The file pointer table 2520 comprises an entry for each file. Each entry comprises a file number 2521, a de-duplication flag 2522, and a file pointer 2523.

The file number 2521 shows the number of the relevant file.

The de-duplication flag 2522 shows whether or not the relevant file has been eliminated in accordance with coarse-grained de-duplication processing. A case where the value of the de-duplication flag 2522 is 0 indicates that the relevant file was not eliminated in accordance with the coarse-grained de-duplication processing. That is, this indicates that the relative file is a new backup. A case where the value of the de-duplication flag 2522 is other than 0 indicates that the relevant file has been eliminated in accordance with the coarse-grained de-duplication processing. A case where the value of the de-duplication flag 2522 is 1 indicates that the relevant file was eliminated because it is duplicated with a preceding (already subjected to coarse-grained de-duplication processing) file inside the same data stream 610. That is, this indicates that a file that is the same as the relevant file exists in the LUT. A case where the value of the de-duplication flag 2522 is 2 indicates that the relevant file was eliminated because it is duplicated with a past backup. That is, this indicates that a file that is the same as the relevant file exists in the LU2.

The file pointer 2523 denotes information showing the location of the relevant file or a file that is duplicated with the relevant file in the LUT. In a case where the relevant file de-duplication flag 2522 is 0, the file pointer 2523 points to the location of the file in the LUT. Ina case where the relevant file de-duplication flag 2522 is 1, the file pointer 2523 points to the location of the file pointer 2523 of a file that is duplicated with the relevant file in the file pointer table 2520. In a case where the relevant file de-duplication flag 2522 is 2, the file pointer 2523 points to the location of the chunk list pointer 2545 of a file that is duplicated with the relevant file in the chunk pointer table 2540 in the LU2.

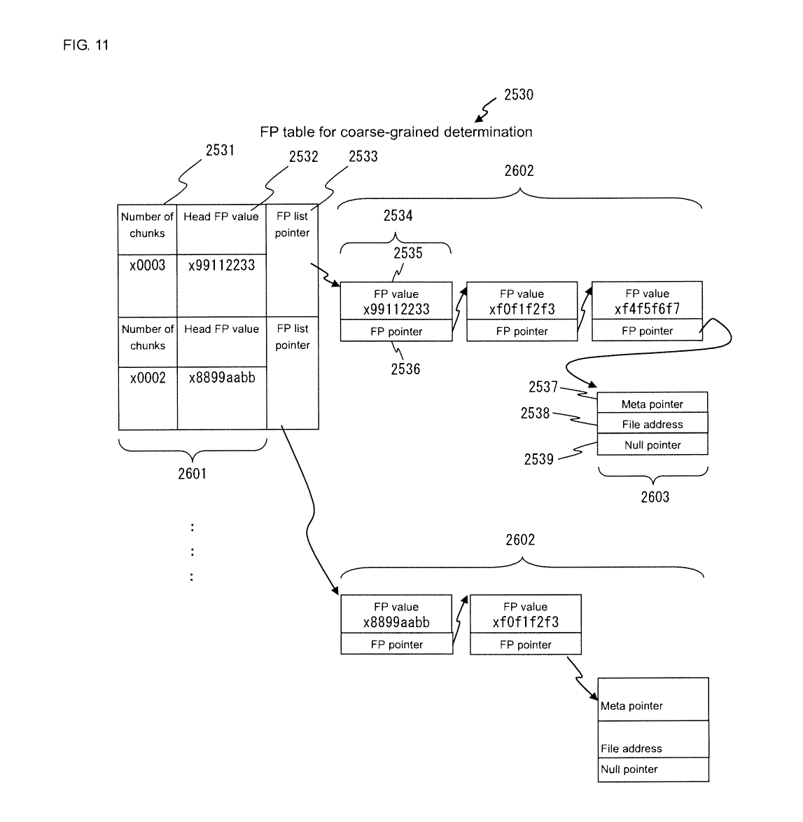

FIG. 11 shows the FP table for coarse-grained determination 2530. The FP table for coarse-grained determination 2530 comprises a scan key 2601, a FP list pointer 2533, and a by-file FP list 2602 for each file, which has been determined by the coarse-grained de-duplication processing not to duplicate a past file.

The scan key 2601 comprises a number of chunks 2531 and a head FP value 2532. The number of chunks 2531 is the number of chunks in the relevant file. The head FP value 2532 is the value of the FP computed based on the first chunk in the relevant file. The scan key 2601 may be the head FP value 2532.

The FP list pointer 2533 points to the head location of an FP list 2602 of the relevant file.

The FP list 2602 is a linear list, and comprises a number of FP nodes 2534 and an end node 2603, which is the terminal node. The number of FP nodes 2534 is equivalent to the number of chunks 2531.

A FP node 2534 corresponds to each chunk in the relevant file. The FP node 2534 corresponding to each chunk comprises a FP value 2535 and a FP pointer 2536. The FP value 2535 is the value of the FP computed based on the relevant chunk. The FP pointer 2536 points to the head location of the next FP node 2534.

The end node 2603 comprises a meta pointer 2537, a file address 2538, and a Null pointer 2539. The meta pointer 2537 points to the location in the LU2 where the relevant file meta information 2546 is stored. The file address 2538 points to the location inside the LUT where the relevant file is stored. The Null pointer 2539 shows that this location is at the end of the FP list 2602.

The head FP value 2532 is equivalent to the FP value 2535 inside the head FP node 2534 in the corresponding FP list 2602.

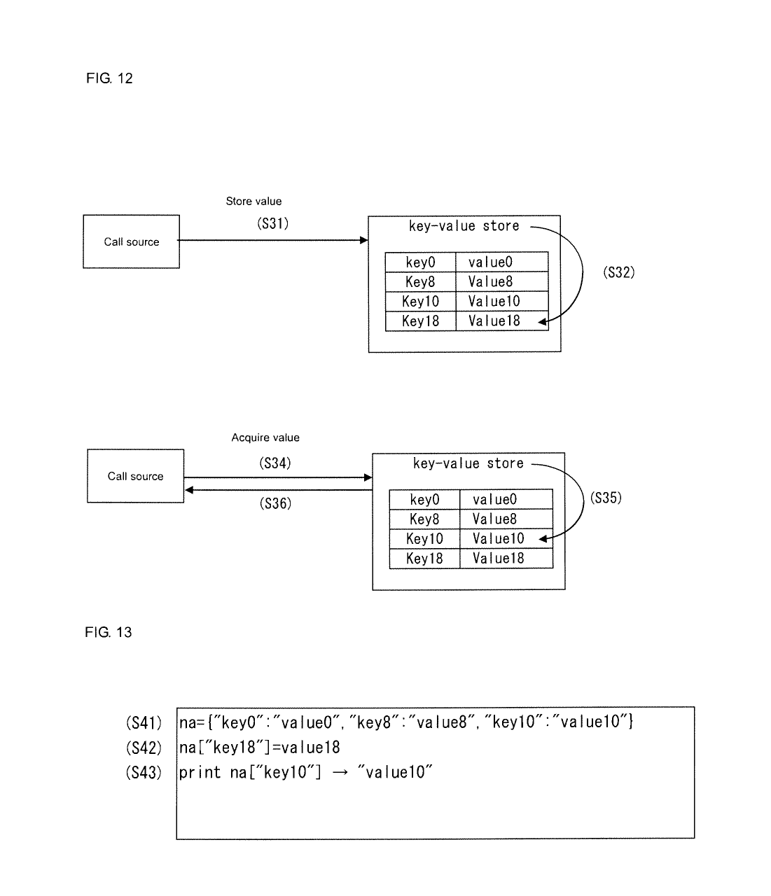

A case in which a key-value store is used in the FP table for coarse-grained determination 2530 will be explained here. FIG. 12 shows a key-value store operation. The coarse-grained de-duplication control part 2410 calls a key-value store to either store or acquire a FP list 2602.

When storing a FP list 2602, in S31, the call-source coarse-grained de-duplication control part 2410 transfers the scan key 2601 as the key and the FP list 2602 as the value to the key-value store. Next, in S32, the key-value store stores the transferred key and value.

When acquiring the FP list 2602, in S34, the call source specifies the scan key 2601 as the key to the key-value store. Next, in S35, the key-value store retrieves the specified key and identifies the value. Next, in S36, the key-value store returns the identified value to the call source.

Next, a case in which a named array is used in the FP table for coarse-grained determination 2530 will be explained. FIG. 13 shows a named array operation. The coarse-grained de-duplication control part 2410 calls the named array to either store or acquire the FP list 2602.

First, in S41, na is defined as the named array. When storing the FP list 2602, in S42, the call source stores the scan key 2601 as the key and the FP list 2602 as the value in the named array. When acquiring the FP list 2602, in S43, the call source specifies the scan key 2601 as the key, and acquires a value corresponding to the specified key.

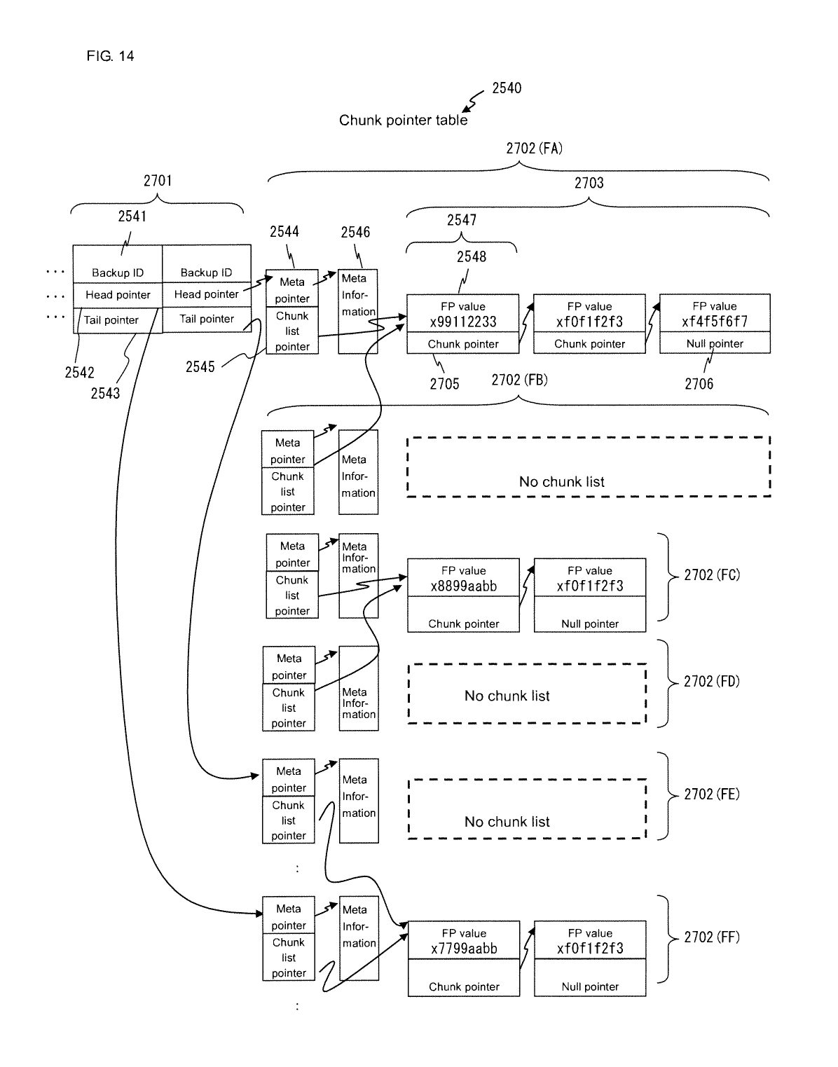

FIG. 14 shows the chunk pointer table 2540. The chunk pointer table 2540 comprises backup management information 2701 for managing multiple generations of backups, and file information 2702, which is information on each file in each backup.

The backup management information 2701 comprises an entry for each backup. Each entry comprises a backup ID 2541, a head pointer 2542, and a tail pointer 2543. The backup ID 2541 is the backup identifier. The head pointer 2542 points to the location of the file information 2702 of the header file from among the files belonging to the relevant backup. The tail pointer 2543 points to the location of the file information 2702 of the tail file from among the files belonging to the relevant backup.

The file information 2702 comprises a meta pointer 2544, a chunk list pointer 2545, meta information 2546, and a chunk list 2703. The meta pointer 2544 points to the location of the meta information 2546 of the relevant file. Also, the head pointer 2542 of the backup management information 2701 described hereinabove points to the location of the meta pointer 2544 of the file information 2702 of the head file in the relevant backup. The chunk list pointer 2545 is associated with the meta pointer 2544, and points to the information of the chunk list 2703 of the relevant file. The meta information 2546 is information added to the relevant file in the data stream 610 by the backup server 300. The meta information 2546 may be stored outside of the chunk pointer table 2540 in the LU2.

The chunk list 2703 comprises a chunk node 2547 for each chunk of the relevant file. The chunk node 2547 comprises a FP value 2548 and a chunk pointer 2705. The FP value 2548 is the value of the FP calculated based on the relevant chunk. Here, the chunk list pointer 2545 described hereinabove points to the location of the FP value 2548 of the chunk node 2547 corresponding to the head chunk of the file.

The chunk pointer 2705 points to the location of the FP value 2548 of the next chunk. The chunk node 2547, which corresponds to the end chunk of a certain file, comprises a Null pointer 2706 in place of the chunk pointer 2705. The Null pointer 2706 shows that this location is the end of the chunk list 2703.

The multiple pieces of file information 2702 in the example respectively show the files FA, FB, FC, FD, FE, and FF. It is supposed here that the data stream 610 of this backup comprises the FA, the FE, the FC, the FD, and the FE, and that the data stream of the previous backup comprises the FF.

It is supposed here that the FB is duplicated with the FA, which is ahead in the same data stream 610. In this case, the FB chunk list pointer 2545 points to the head location of the FA chunk list 2703. In accordance with this, the chunk list 2703 does not exist in the FB file information 2702.

It is also supposed that the FD is duplicated with the FC, which is ahead in the same data stream 610. In this case, the FD chunk list pointer 2545 points to the head location of the FC chunk list 2703. In accordance with this, the chunk list 2703 does not exist in the FC file information 2702.

It is also supposed that the FE is duplicated with the FF in the previous backup. In this case, the FE chunk list pointer 2545 points to the head location of the FF chunk list 2703. In accordance with this, the chunk list 2703 does not exist in the FE file information 2702.

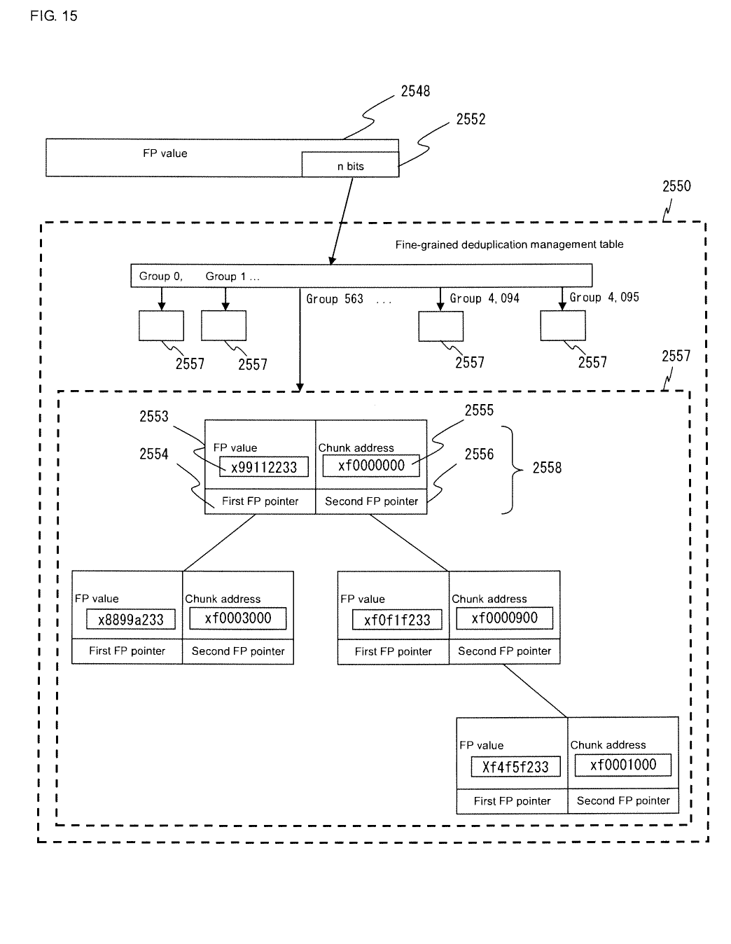

FIG. 15 shows the fine-grained de-duplication management table 2550. The FP value 2548 of each chunk, which is deduplicated in accordance with the fine-grained de-duplication process, is categorized into a group, in which the bit pattern of the last n bits of the bit pattern thereof is the same. The n-bit bit pattern is regarded as a group identifier 2552. In a case where n is 12, the group identifier 2552 is expressed as 0, 1, . . . , 4095.

The fine-grained de-duplication management table 2550 comprises a binary tree 2557 for each group identifier 2552. A node 2558 inside the binary tree 2557 corresponds to a chunk. Each node 2558 comprises a FP value 2553, a chunk address 2555, a first FP pointer 2554, and a second FP pointer 2556.

The FP value 2553 is the value of the FP belonging to the corresponding group. That is, the last n bits of the FP value 2553 constitute the group identifier 2552 of the corresponding group. The chunk address 2555 shows the location where the chunk corresponding to the FP value 2553 is stored in the LU2. The chunk address 2555 may be a physical address, or may be a logical address. The first FP pointer 2554 points to a node comprising a FP value 2553, which is smaller than the FP value 2553 of the relevant node. The second FP pointer 2556 points to a node comprising a FP value 2553, which is larger than the FP value 2553 of the relevant node.

Registering a deduplicated FP value 2553 in the fine-grained de-duplication management table 2550 makes it possible to hold down the size of the fine-grained de-duplication management table 2550.

According to this data structure, in a case where a certain target FP value is retrieved, a group identifier 2552 is recognized based on the target FP value, and a binary tree 2557 corresponding to the group identifier 2552 is selected. Next, in a case where the target FP value is smaller than the FP value 2553 of the node, the processing moves from the root node of the selected binary tree 2557 to the node pointed to by the first FP pointer 2554, and in a case where the target FP value is larger than the FP value 2553 of the node, the processing moves from the root node of the selected binary tree 2557 to the node pointed to by the second FP pointer 2556. Repeating this process makes it possible to reach the target FP value node and acquire the chunk address 2555 of the node thereof.

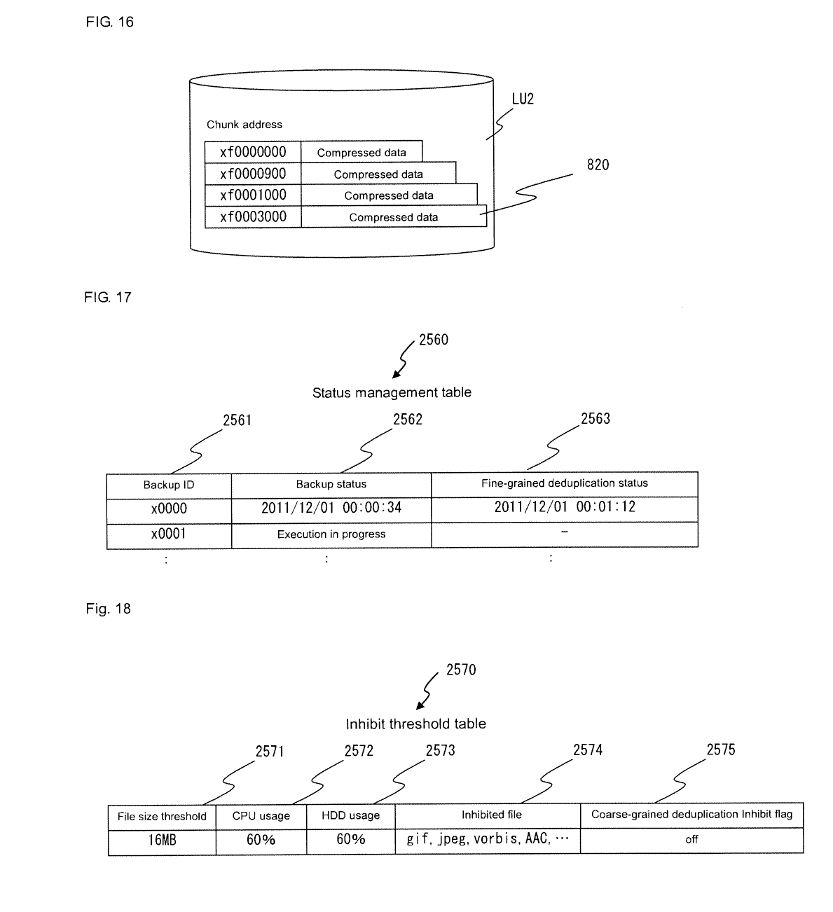

FIG. 16 shows the disposition of compressed data 820 in the backup destination. The chunk address 2555 points to the location of the compressed data 820 of each chunk stored in the LU2. The chunks at this point have undergone de-duplication. Therefore, the chunk address 2555 corresponding to the FP value 2548 can be identified at high speed using the fine-grained de-duplication management table 2550. In accordance with this, it is possible to access the compressed data 820 of a chunk in the LU2 at high speed based on the FP value 2548. A logical page number or other such management number, which shows the logical location in the LU2, may be used in place of the chunk address 2555.

FIG. 17 shows the status management table 2560. The status management table 2560 comprises an entry for each backup. Each entry comprises a backup ID 2561, a backup status 2562, and a fine-grained de-duplication status 2563. The backup ID 2561 is the identifier of the same backup as the backup ID 2541. The backup status 2562, in a case where the relevant backup has been completed, shows the time at which this backup was completed, and in a case where the relevant backup is in the process of being executed, shows “execution in progress”. The fine-grained de-duplication status 2563, in a case where fine-grained de-duplication processing has been completed, shows the time at which the fine-grained de-duplication process was completed.

FIG. 18 shows the inhibit threshold table 2570. The inhibit threshold table 2570 is used in coarse-grained de-duplication inhibit processing, which inhibits the coarse-grained de-duplication process in order to reduce the load on the storage apparatus 200. The inhibit threshold table 2570 comprises a file size threshold 2571, a CPU usage threshold 2572, a HDD usage threshold 2573, an inhibited file 2574, and a coarse-grained de-duplication inhibit flag 2575.

The file size threshold 2571 is the threshold of the file size for inhibiting the coarse-grained de-duplication process. For example, in a case where the size of a certain file in the data stream 610 received by the storage apparatus 200 exceeds the file size threshold 2571, the coarse-grained de-duplication inhibit process removes this file as a target of the coarse-grained de-duplication processing. The CPU usage threshold 2572 is the threshold of the CPU usage for changing the file size threshold 2571. The HDD usage threshold 2573 is the threshold of the HDD usage for changing the file size threshold 2571. The inhibited file 2574 shows the type of file, which will not become a target of the coarse-grained de-duplication processing. For example, the coarse-grained de-duplication inhibit process, in a case where a certain type of file in the data stream 610 received by the storage apparatus 200 is included in the inhibited file 2574, removes this file as a target of the coarse-grained de-duplication processing. The inhibited file 2574 may show an attribute, such as an access privilege or an access date/time. The coarse-grained de-duplication inhibit flag 2575 is a flag for configuring whether or not to inhibit the coarse-grained de-duplication processing.

### Backup Control Process

A backup control process by the backup control part 2440 will be explained below.

The backup control part 2440 executes a backup control process in accordance with a backup control processing instruction from the backup server 300. The backup control process comprises a first backup control process, and a second backup control process executed subsequent thereto.

The first backup control process will be explained below.

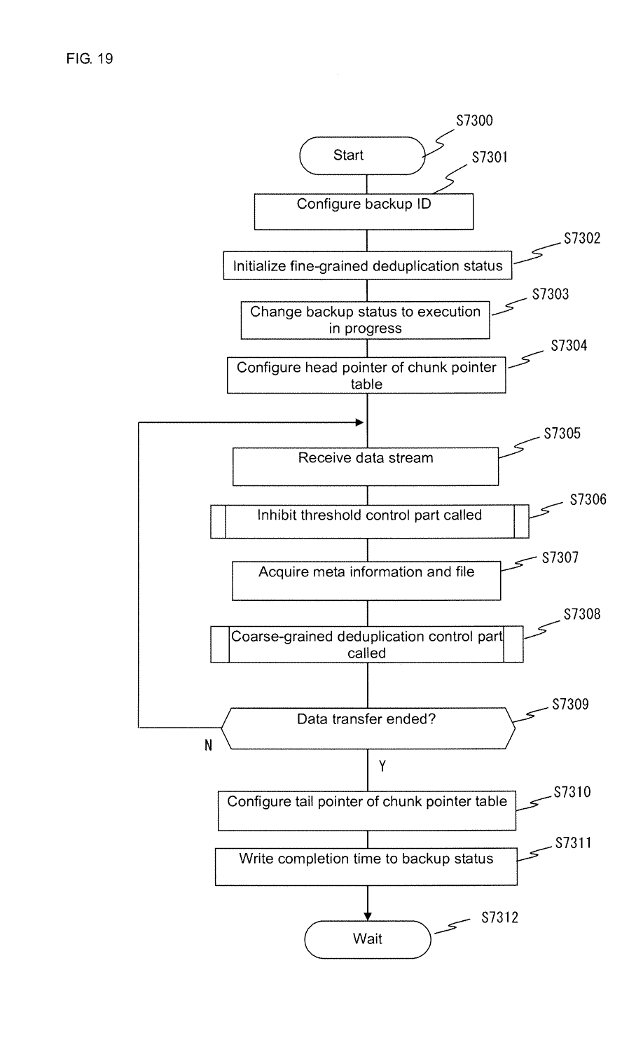

FIG. 19 shows the first backup control process. In S7300, the backup control part 2440 starts the first backup control process upon receiving a backup control processing instruction from the backup application 3400 of the backup server 300. It is supposed that the instructed backup generation is the target backup here.

Next, in S7301, the backup control part 2440 configures a backup ID 2561 of the target backup in the status management table 2560. Next, in S7302, the backup control part 2440 initializes (clears) the fine-grained de-duplication status 2563 in the status management table 2560. Next, in S7303, the backup control part 2440 changes the backup status 2562 in the status management table 2560 to “execution in progress”. Next, in S7304, the backup control part 2440 configures a head pointer of 2542 of the target backup in the chunk pointer table 2540.

Next, in S7305, when a file is transferred to the backup server 300 from the LU1 of the storage apparatus 100, and a data stream 610 is transferred from the backup server 300 to the storage apparatus 200, the backup control part 2440 receives the data stream 610. Next, in S7306, the backup control part 2440 performs inhibit threshold control processing, which will be explained further below, in accordance with calling the inhibit threshold control part 2460. Next, in S7307, the backup control part 2440 acquires one piece of meta information and the subsequent file thereto from the received data stream 610. Next, in S7308, the backup control part 2440 executes the coarse-grained de-duplication process, which will be explained further below, for the acquired meta information and file in accordance with calling the coarse-grained de-duplication control part 2410. Next, in S7309, the backup control part 2440 determines whether or not the transfer of the target backup data from the LU1 has ended.

In a case where the result of S7309 is N, that is, a case in which the transfer of the target backup data stream 610 has not ended, the backup control part 2440 moves the processing to the above-described S7305.

In a case where the result of S7309 is Y, that is, a case in which the transfer of the target backup data stream 610 has ended, the backup control part 2440 advances the processing to S7310.

In S7310, the backup control part 2440 configures a tail pointer 2543 of the target backup in the chunk pointer table 2540. Next, in S7311, the backup control part 2440 writes the completion time to the backup status 2562 in the status management table 2560. Next, in S7312, the backup control part 2440 waits.

The preceding is the first backup control process.

According to the first backup control process, it is possible to execute coarse-grained de-duplication process, which is the in-line de-duplication process.

The second backup control process will be explained below.

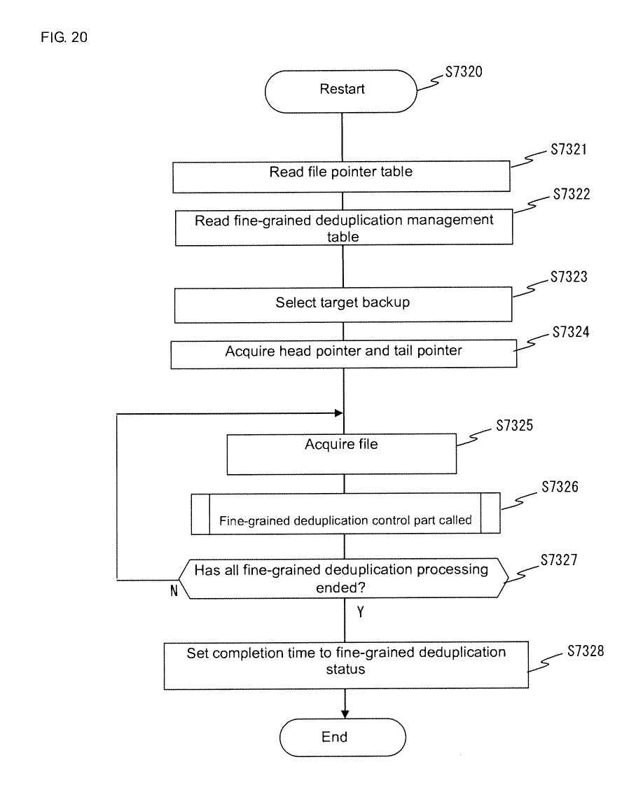

FIG. 20 shows the second backup control process. In S7320, the backup control part 2440 starts the second backup control process upon being restarted by the schedule management process, which will be explained further below.

Next, in S7321, the backup control part 2440 reads the file pointer table 2520 from the LUT and stores this table in the shared memory 120. Next, in S7322, the backup control part 2440 reads the fine-grained de-duplication management table 2550 from the LU2 and stores this table in the shared memory 120. Next, in S7323, the backup control part 2440 recognizes the target backup in accordance with referencing the status management table 2560. Next, in S7324, the backup control part 2440 acquires the head pointer 2542 and the tail pointer 2543 of the target backup from the chunk pointer table 2540.

Next, in S7325, the backup control part 2440 selects a file, which has not been deduplicated, from the file pointer table 2520, reads the selected file from the LUT, and stores this file in the cache memory 130. Next, in S7326, the backup control part 2440 executes the fine-grained de-duplication process, which will be explained further below, for the read file by calling the fine-grained de-duplication control part 2420. Next, in S7327, the backup control part 2440 determines whether or not fine-grained de-duplication processing has ended for all of the non-deduplicated files.

In a case where the result of S7327 is N, that is, a case in which fine-grained de-duplication processing has not ended for all of the non-deduplicated files, the backup control part 2440 moves the processing to the above-described S7325.

In a case where the result of S7327 is Y, that is, a case in which fine-grained de-duplication processing has ended for all of the non-deduplicated files, the backup control part 2440 advances the processing to S7328. In S7328, the backup control part 2440 sets the completion time, which is in the fine-grained de-duplication status 2563 for the target backup, in the status management table 2560.

The preceding is the second backup control process.

According to the second backup control process, it is possible to execute the fine-grained de-duplication process, which is the post-process de-duplication process.

The inhibit threshold control process in S7306 of the above-described first backup control process will be explained below.

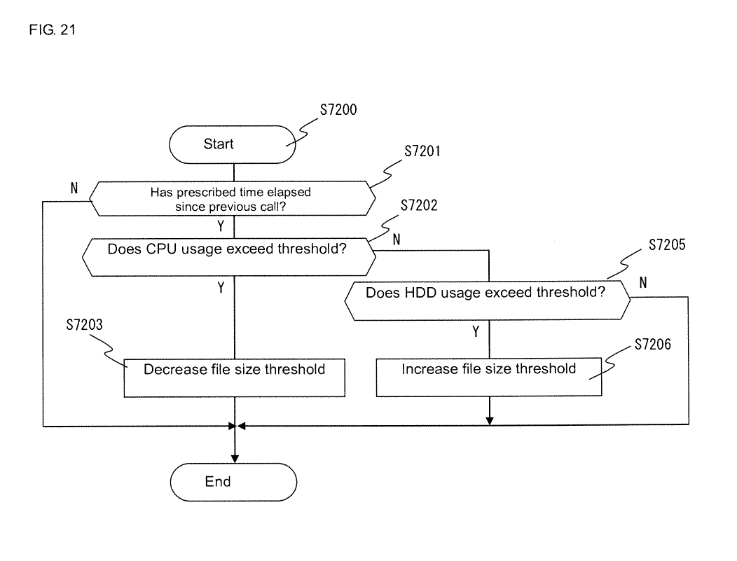

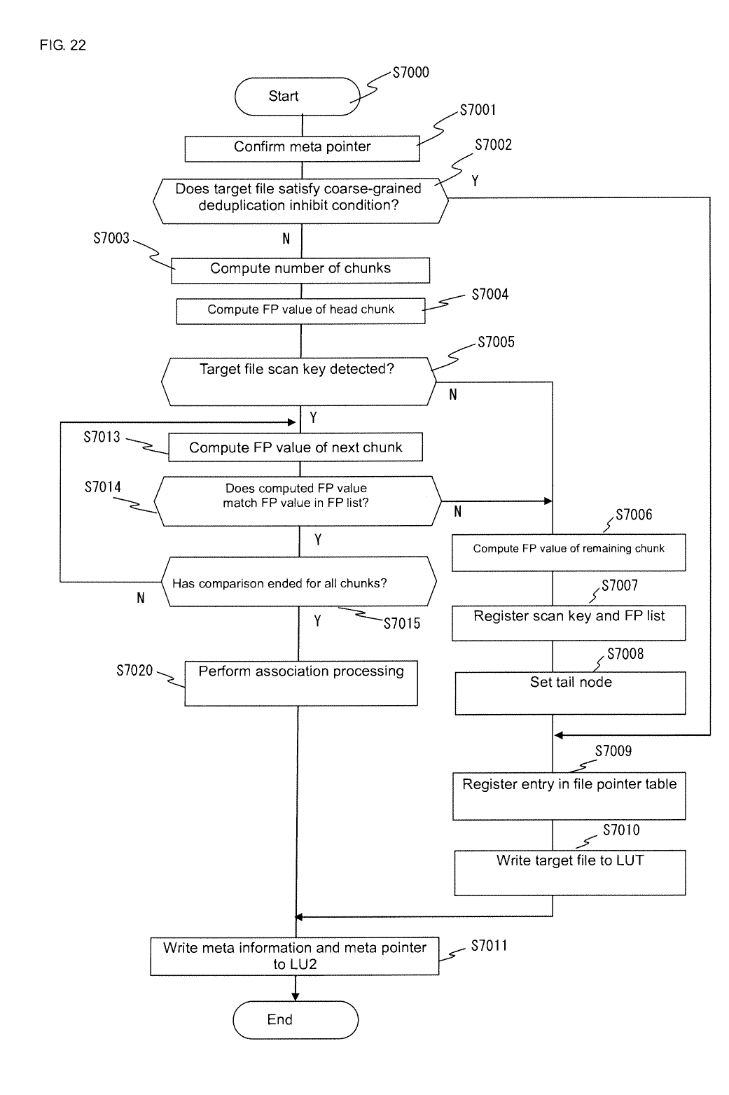

FIG. 21 shows the inhibit threshold control process. In S7200, the inhibit threshold control process starts when the inhibit threshold control part 2460 is called.

Next, in S7201, the inhibit threshold control part 2460 determines whether or not a period of time equal to or longer than a prescribed time interval has elapsed since the previous call. The prescribed time interval, for example, is one minute.

In a case where the result of S7201 is N, that is, a case in which a period of time equal to or longer than the prescribed time interval has not elapsed since the previous call was performed, the inhibit threshold control part 2460 ends this flow.

In a case where the result of S7201 is Y, that is, a case in which a period of time equal to or longer than the prescribed time interval has elapsed since the previous call was performed, the inhibit threshold control part 2460 advances the processing to S7202. In S7202, the inhibit threshold control part 2460 determines whether or not the CPU usage of the storage apparatus 200 has exceeded the CPU usage threshold 2572.

In a case where the result of S7202 is Y, that is, a case in which the CPU usage of the storage apparatus 200 has exceeded the CPU usage threshold 2572, the inhibit threshold control part 2460 advances the processing to S7203. In S7203, the inhibit threshold control part 2460 decreases the file size threshold 2571 in the inhibit threshold table 2570 by a prescribed decremental step, and ends this flow. The prescribed decremental step, for example, may be the chunk size or a multiple of the chunk size.

In a case where the result of S7202 is N, that is, a case in which the CPU usage of the storage apparatus 200 does not exceed the CPU usage threshold 2572, the inhibit threshold control part 2460 advances the processing to S7205. In S7205, the inhibit threshold control part 2460 determines whether or not the LUT HDD usage in the storage apparatus 200 has exceeded the HDD usage threshold 2573.

In a case where the result of S7205 is Y, that is, a case in which the HDD usage has exceeded the HDD usage threshold 2573, the inhibit threshold control part 2460 advances the processing to S7206. In S7206, the inhibit threshold control part 2460 increases the file size threshold 2571 in the inhibit threshold table 2570 by a prescribed incremental step, and ends this flow. The prescribed incremental step, for example, may be the chunk size or a multiple of the chunk size.

In a case where the result of S7205 is N, that is, a case in which the HDD usage does not exceed the HDD usage threshold 2573, the inhibit threshold control part 2460 ends this flow.

The preceding is the inhibit threshold control process.

According to the inhibit threshold control process, the impact of the in-line de-duplication process on access performance can be reduced by inhibiting the coarse-grained de-duplication process in accordance with the load on the storage apparatus 200. For example, in a case where the load on the storage apparatus 200 exceeds a predetermined load threshold, it is possible to reduce the coarse-grained de-duplication processing load by decreasing the number of files targeted for coarse-grained de-duplication processing. For example, in a case where the storage apparatus 200 load is equal to or less than the predetermined load threshold, it is possible to reduce the fine-grained de-duplication processing load by increasing the number of files targeted for coarse-grained de-duplication processing.

The inhibit threshold control part 2460 may change the file size threshold 2571 based on an amount of I/O instead of the load of the storage apparatus 200. The inhibit threshold control part 2460 may also decide whether or not to carry out coarse-grained de-duplication processing based on the amount of I/O. For example, the inhibit threshold control part 2460 will not carry out coarse-grained de-duplication processing in a case where the amount of I/O exceeds a predetermined I/O threshold. In accordance with carrying out coarse-grained de-duplication processing corresponding to the amount of I/O, which changes from moment to moment, coarse-grained de-duplication processing can be carried out without affecting the access performance.

The amount of I/O may be the amount of I/O in accordance with a host computer accessing the storage system 10, or may be the amount of I/O of the storage apparatus 200. The amount of I/O may be the amount of write data (flow volume) per prescribed time period, may be the amount of read data per prescribed time period, or may be a combination thereof.

The impact of in-line de-duplication processing on the access performance can be reduced by inhibiting the coarse-grained de-duplication processing in accordance with the amount of I/O.

The coarse-grained de-duplication processing in S7308 of the above-described first backup control process will be explained below.

FIG. 22 shows the coarse-grained de-duplication process. In S7000, the coarse-grained de-duplication processing starts when the coarse-grained de-duplication control part 2410 is called.

Next, in S7001, the coarse-grained de-duplication control part 2410 acquires meta information and a file, and decides the location in the LU2 where this meta information is stored, thereby confirming the meta pointer pointing at this location. The acquired file will be called the target file here. Next, in S7002, the coarse-grained de-duplication control part 2410, based on the inhibit threshold table 2570, determines whether or not the target file satisfies the coarse-grained de-duplication inhibit condition. At this point, the coarse-grained de-duplication control part 2410 determines that the target file satisfies the coarse-grained de-duplication inhibit condition when the file size of the target file is equal to or larger than the file size threshold 2571, when the target file attribute or file format matches the inhibited file 2574, or when the coarse-grained de-duplication inhibit flag 2575 is ON. For example, the coarse-grained de-duplication control part 2410 detects the target file attribute or file format from the target file header, and determines whether or not this attribute or format matches the inhibit file 2574.

In a case where the result of S7002 is Y, that is, a case in which the target file satisfies the coarse-grained de-duplication inhibit condition, the coarse-grained de-duplication control part 2410 moves the processing to S7009.

In a case where the result of S7002 is N, that is, a case in which the target file does not satisfy the coarse-grained de-duplication inhibit condition, the coarse-grained de-duplication control part 2410 advances the processing to S7003. In S7003, the coarse-grained de-duplication control part 2410 computes the number of chunks in a case where the target file has undergone chunking. Partial data of a size that differs from that of the chunk may be used in place of the chunk here. The size of the partial data in this case is smaller than the size of the file. Next, in S7004, the coarse-grained de-duplication control part 2410 computes the FP value of the head chunk of the target file. Next, in S7005, the coarse-grained de-duplication control part 2410 treats the computed number of chunks and the computed FP value of the head chunk as the target file scan key, searches for the target file scan key in the FP table for coarse-grained determination 2530, and determines whether or not the target file scan key was detected in the FP table for coarse-grained determination 2530. The coarse-grained de-duplication control part 2410 can use the above-described key-value store and named array here.

In a case where the result of S7005 is N, that is, a case in which the target file scan key has not been detected in the FP table for coarse-grained determination 2530, the coarse-grained de-duplication control part 2410 advances the processing to S7006. In S7006, the coarse-grained de-duplication control part 2410 computes the FP value of the remaining chunk of the target file. Next, in S7007, the coarse-grained de-duplication control part 2410 registers the computed number of chunks and the computed FP value as the scan key 2601 and the FP list 2602 in the FP table for coarse-grained determination 2530. Next, in the S7008, the coarse-grained de-duplication control part 2410 decides the location in the LUT where the target file is stored, thereby confirming the file address 2538 pointing to this location, and registers a tail node at the end of the registered FP list 2602. That is, the coarse-grained de-duplication control part 2410 writes the confirmed meta pointer 2537, the confirmed file address 2538, and the Null pointer 2539 to the tail node. Next, in S7009, the coarse-grained de-duplication control part 2410 registers a target file entry in the file pointer table 2520. At this point, the coarse-grained de-duplication control part 2410 writes “0” to the de-duplication flag 2522 for the target file, and writes the confirmed file pointer to the file pointer 2523 for the target file. Next, in S7010, the coarse-grained de-duplication control part 2410 writes the target file to the file address 2538 in the LUT, and advances the processing to S7011.

Next, in S7011, the coarse-grained de-duplication control part 2410 writes the meta information 2546 and the meta pointer 2544 into the file information 2702 for the target file in the chunk pointer table 2540 in the LU2, and ends the flow. Thus, the meta information 2546 is written to the LU2 without being deduplicated. The size of the meta information 2546 is smaller than that of the file, and there is a low likelihood of meta information 2546 being duplicated.

In a case where the result of S7005 is Y, that is, a case in which the target file scan key has been detected in the FP table for coarse-grained determination 2530, the coarse-grained de-duplication control part 2410 moves the processing to S7013. Next, in S7013, the coarse-grained de-duplication control part 2410 selects the next chunk and computes the FP value of the selected chunk. Next, in S7014, the coarse-grained de-duplication control part 2410 selects the FP list 2602 corresponding to the detected scan key, selects the FP value 2535 corresponding to the location of the selected chunk from the selected FP list 2602, compares the computed FP value to the selected FP value 2535, and determines whether or not the computed FP value matches the selected FP value 2535.

In a case where the result of S7014 is N, that is, a case in which the computed FP value does not match the selected FP value 2535, the coarse-grained de-duplication control part 2410 moves the processing to S7006.

In a case where the result of S7014 is Y, that is, a case in which the computed FP value matches the selected FP value 2535, the coarse-grained de-duplication control part 2410 advances the processing to S7015. Next, in S7015, the coarse-grained de-duplication control part 2410 determines whether or not the comparisons of the FP values for all the chunks of the target file have ended.

In a case where the result of S7015 is N, that is, a case in which the comparisons of the FP values of all the chunks of the target file have not ended, the coarse-grained de-duplication control part 2410 moves the processing to the above-described S7013.

In a case where the result of S7015 is Y, that is, a case in which the comparisons of the FP values of all the chunks of the target file have ended and the FP values of all the chunks of the target file match the selected FP list 2602, the coarse-grained de-duplication control part 2410 moves the processing to the S7020. Next, in S7020, the coarse-grained de-duplication control part 2410 performs an association process, which will be explained further below, and moves the processing to the above-described S7011.

The preceding is the coarse-grained de-duplication process.

The association process in S7020 of the above-described coarse-grained de-duplication processing will be explained here.

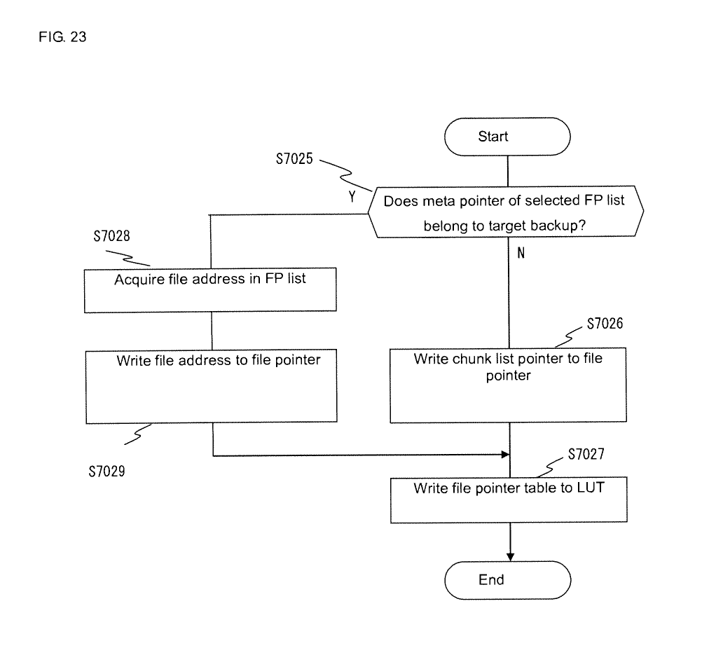

FIG. 23 shows the association process.

First, in S7025, the coarse-grained de-duplication control part 2410 acquires the meta pointer 2537 of the tail node 2603 of the selected FP list 2602 in the FP table for coarse-grained determination 2530, and determines whether or not the acquired meta pointer 2537 belongs to the target backup. Here, the coarse-grained de-duplication control part 2410, for example, acquires the head pointer 2542 and the tail pointer 2543 for the backup ID 2541 of the target backup from the chunk pointer table 2540, and in a case where the acquired meta pointer 2537 falls within the range from the head pointer 2542 to the tail pointer 2543, determines that the meta pointer 2537 at the end of the selected FP list 2602 belongs to the target backup.

In a case where the result of S7025 is N, that is, a case in which the acquired meta pointer 2537 does not belong to the target backup, the coarse-grained de-duplication control part 2410 advances the processing to S7026. In this case, the target file is duplicated with a file in a past generation backup. In S7026, the coarse-grained de-duplication control part 2410 registers a target file entry in the file pointer table 2520. Here, the coarse-grained de-duplication control part 2410 writes “2” to the target file de-duplication flag 2522, acquires the chunk list pointer 2545, which is associated with the meta pointer 2537 in the chink pointer table 2540, and writes the acquired chunk list pointer 2545 to the file pointer 2523 of the target file.

Next, in S7027, the coarse-grained de-duplication control part 2410 writes the target file and the file pointer table 2520 to the LUT, and moves the processing to the above-described S7011.

In a case where the result of S7025 is Y, that is, a case in which the acquired meta pointer 2537 belongs to the target backup, the coarse-grained de-duplication control part 2410 moves the processing to S7028. In this case, the target file is duplicated with a file that is ahead of it in the data stream 610 of the target backup. In S7028, the coarse-grained de-duplication control part 2410 acquires from the FP table for coarse-grained determination 2530 the file address 2538 in the tail node 2603 of the selected FP list 2602. Next, in S7029, the coarse-grained de-duplication control part 2410 changes the target file entry in the file pointer table 2520. Here, the coarse-grained de-duplication control part 2410 writes “1” to the target file de-duplication flag 2522, and writes the acquired file address 2538 to the file pointer 2523 of the target file.

The preceding is the association process.

According to the coarse-grained de-duplication process, data is compared in file units, and a file, which is duplicated with a file written to the LUT or the LU2 in the past, is eliminated, thereby enabling only non-redundant files to be targeted for fine-grained de-duplication processing. In addition, the coarse-grained de-duplication control part 2410, in determining whether or not the target file is duplicated with a past file, first calculates and compares the FP values of the chunks at the head of the target file, and in a case where these values match, calculates and compares the FP values of the subsequent chunks, thereby making it possible to delete data targeted for FP value calculation, and to reduce the coarse-grained de-duplication processing load.

When the size of the file is large in a conventional in-line de-duplication process, the in-line de-duplication processing may take time and may cause a decrease in the access performance from the host computer to the storage system. According to the coarse-grained de-duplication processing of the example, the impact on the access performance can be reduced by inhibiting the coarse-grained de-duplication process in accordance with the file size.

In a conventional in-line de-duplication process, the file format may render the in-line de-duplication processing ineffective. In accordance with this, the in-line de-duplication processing may also cause a drop in the access performance. According to the coarse-grained de-duplication processing of the example, the impact on the access performance can be reduced by inhibiting the coarse-grained de-duplication processing in accordance with the file format.

The amount of I/O from the host computer to the storage system changes from one moment to the next, and as such, in a case where the I/O load on the storage system is high in a conventional in-line de-duplication process, the in-line de-duplication processing may cause the access performance to drop. According to the coarse-grained de-duplication processing of the example, the impact on the access performance can be reduced by inhibiting the coarse-grained de-duplication processing in accordance with the amount of I/O of the storage apparatus 200.

In a conventional in-line de-duplication process, the comparison of data in file units may cause a drop in access performance. According to the coarse-grained de-duplication processing of the example, the impact on the access performance can be reduced by comparing the FP value of each part of a file.

In addition, the coarse-grained de-duplication process performs low-load, high-speed de-duplication for a file by separating the meta information and the file, and writing the meta data ahead of the file to the LU2, which is the backup destination, without writing the meta data to the LUT, which is a temporary storage area, thereby making it possible to reduce the amount of writing to the temporary storage area.

Schedule management processing by the schedule management part 2430 will be explained below.

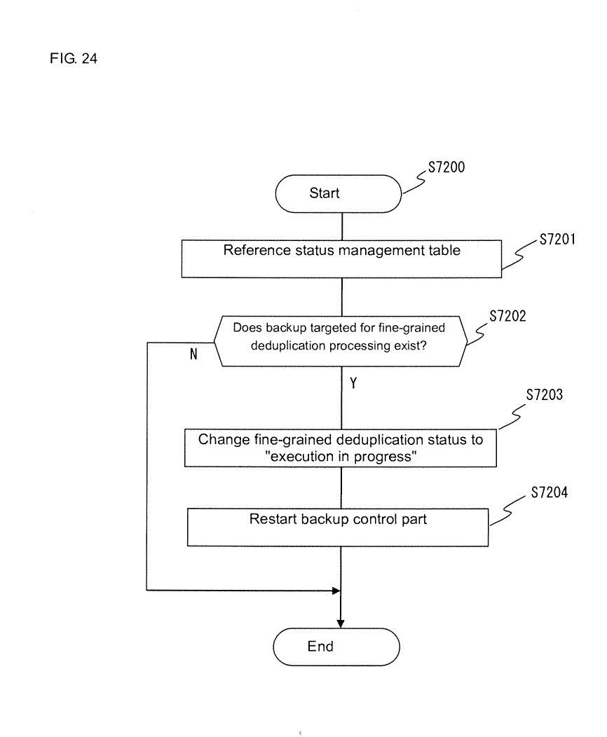

FIG. 24 shows the schedule management process. The schedule management part 2430 executes schedule management processing on a regular basis.

First, in S7201, the schedule management part 2430 references the backup status 2562 and the fine-grained de-duplication status 2563 in the status management table 2560. Next, in S7202, the schedule management part 2430 determines whether or not a backup targeted for fine-grained de-duplication processing exists. In a case where a completion time for a certain backup is recorded in the backup status 2562, but is not recorded in the fine-grained de-duplication status 2563, the schedule management part 2430 determines that fine-grained de-duplication processing should be executed for the relevant backup.

In a case where the result of S7202 is N, that is, a case in which there is no backup for which fine-grained de-duplication processing should be executed, the schedule management part 2430 ends this flow.

In a case where the result of S7202 is Y, that is, a case in which there is a backup for which fine-grained de-duplication processing should be executed, the schedule management part 2430 advances the processing to S7303. In S7203, the schedule management part 2430 changes the fine-grained de-duplication status 2563 to “execution in progress”. In S7304, the schedule management part 2430 starts the above-described second backup control process by restarting the backup control part 2440 for fine-grained de-duplication processing.

The preceding is the schedule management process.

According to the schedule management process, a first backup control process and a second backup control process can be executing asynchronously.

The fine-grained de-duplication processing in S7326 of the above-described second backup control process will be explained below.

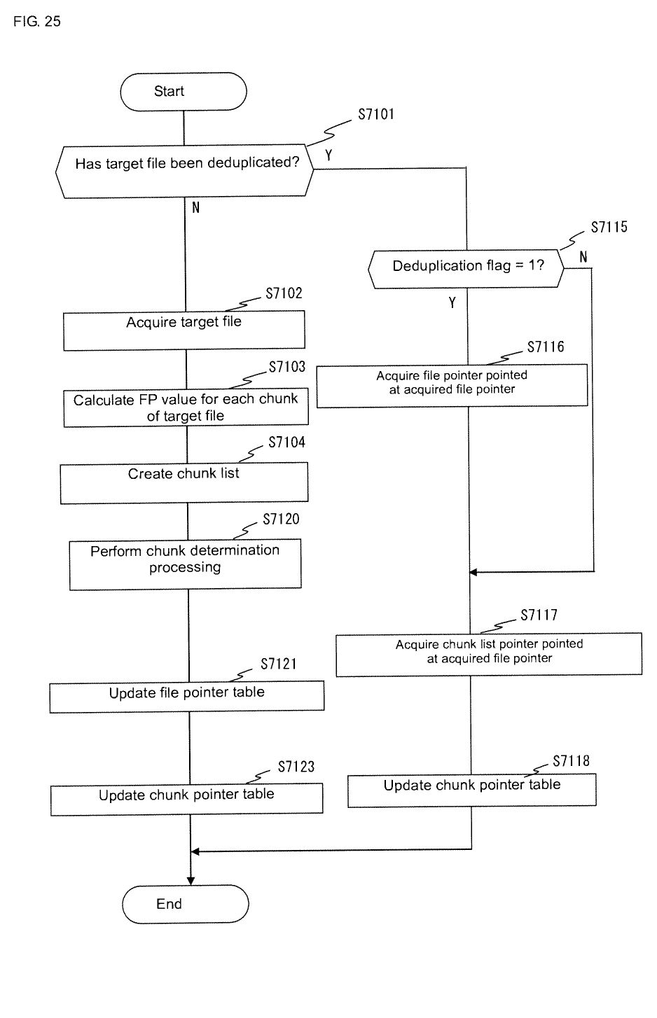

FIG. 25 shows the fine-grained de-duplication process.

First, in S7101, the fine-grained de-duplication control part 2420 determines whether or not the target file has been deduplicated in accordance with coarse-grained de-duplication processing. Here, the fine-grained de-duplication control part 2420 acquires the target-file entry from the file pointer table 2520, acquires the de-duplication flag 2522 and the file pointer 2523 from this entry, and when the acquired de-duplication flag 2522 is other than “0”, determines that the target file has been deduplicated.

In a case where the result of S7101 is N, that is, a case in which the target file has not been deduplicated, the fine-grained de-duplication control part 2420 advances the processing to S7102. Next, in S7102, the fine-grained de-duplication control part 2420 acquires the target file shown by the target-file file pointer 2523 in the file pointer table 2520. Next, in S7103, the fine-grained de-duplication control part 2420 subjects the target file to chunking, and in accordance with this, calculates a FP value for each obtained chunk. Next, in S7104, the fine-grained de-duplication control part 2420 creates a target-file chunk list 2703 based on the calculated FP values. Next, in S7120, the fine-grained de-duplication control part 2420 performs a chunk determination process, which will be explained further below.

Next, in S7121, the fine-grained de-duplication control part 2420 updates the target-file entry in the file pointer table 2520. Here, the fine-grained de-duplication control part 2420 changes the target-file de-duplication flag 2522 to “2”, acquires the chunk list pointer 2545 pointing to the location of the target-file chunk list 2703, and changes the target-file file pointer 2523 to the acquired chunk list pointer 2545. Next, in S7123, the fine-grained de-duplication control part 2420 updates the chunk pointer table 2540 by writing the acquired chunk list pointer 2545 and the created chunk list 2703 to the chunk pointer table 2540 in the LU2, and ends this flow.

In a case where the result of S7101 is Y, that is, a case in which the target file has been deduplicated, the fine-grained de-duplication control part 2420 moves the processing to S7115. Next, in S7115, the fine-grained de-duplication control part 2420 determines whether or not the target-file de-duplication flag 2522 is “1”.

In a case where the result of S7115 is N, that is, a case in which the target-file de-duplication flag 2522 is “2”, the fine-grained de-duplication control part 2420 moves the processing to S7117. The target-file file pointer 2523 points to the locations of the chunk list pointers 2545 for the target file and the duplicate file at this time.

In a case where the result of S7115 is Y, that is, a case in which the target-file de-duplication flag 2522 is “1”, the fine-grained de-duplication control part 2420 acquires the file pointer 2523, which had pointed to the acquired file pointer 2523. At this time, the target-file file pointer 2523 points to the location of the file pointer 2523 of the file, which is ahead of the target file inside the same data stream 610 and is duplicated with the target file. Furthermore, the file pointer 2523 of the target file and the duplicate file points to the chunk list pointers 2545 of these files in accordance with S7121 being performed in advance.

Next, in S7117, the fine-grained de-duplication control part 2420 acquires the chunk list pointer 2545, which had pointed to the acquired file pointer 2523. Next, in S7118, the fine-grained de-duplication control part 2420 writes the acquired chunk list pointer 2545 to the target-file chunk list pointer 2545 in the chunk pointer table 2540 of the LU2, and ends this flow.

The preceding is the fine-grained de-duplication process.

The chunk determination processing in S7120 of the above-described fine-grained de-duplication process will be explained here.

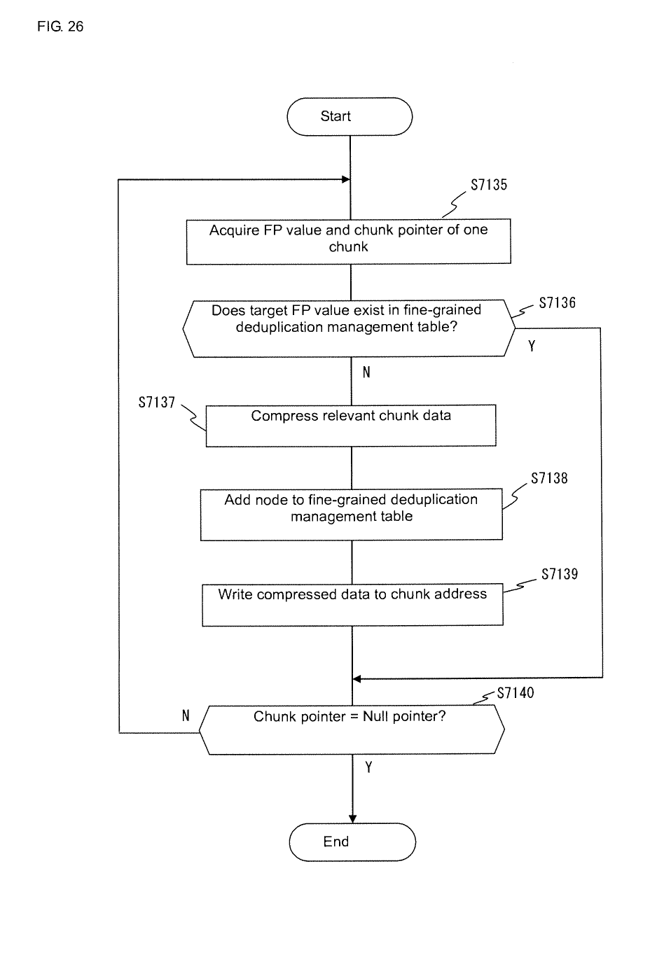

FIG. 26 shows the chunk determination process.

First, in S7135, the fine-grained de-duplication control part 2420 selects one chunk from inside the target file, treats this chunk as the target chunk, acquires target-chunk chunk node 2547 from the created chunk list 2703, and acquires the FP value 2548 and the chunk pointer 2705 from the acquired chunk node 2547. The FP value acquired here will be called the target FP value. Next, in S7136, the fine-grained de-duplication control part 2420 determines whether or not the target FP value exists in the fine-grained de-duplication management table 2550. As described hereinabove, the fine-grained de-duplication control part 2420 acquires the group identifier 2552 for the target FP value here, searches the node of the target FP value using the binary tree 2557 corresponding to the acquired group identifier 2552, and acquires the chunk address 2555 of this node.

In a case where the result of S7136 is Y, that is, a case in which the acquired FP value exists in the fine-grained de-duplication management table 2550, the fine-grained de-duplication control part 2420 moves the processing to S7140.

In a case where the result of S7136 is N, that is, a case in which the acquired FP value does not exist in the fine-grained de-duplication management table 2550, the fine-grained de-duplication control part 2420 advances the processing to S7137. Next, in S7137, the fine-grained de-duplication control part 2420 creates compressed data in accordance with compressing the data of the target chunk. Next, in S7138, the fine-grained de-duplication control part 2420 decides on a chunk address for storing the target chunk in the LU2, and adds the node 2558 comprising the target FP value and the decided chunk address to the fine-grained de-duplication management table 2550. Next, in S7139, the fine-grained de-duplication control part 2420 writes the target-chunk compressed data to the decided chunk address.

Next, in S7140, the fine-grained de-duplication control part 2420 determines whether or not the acquired chunk pointer 2705 is the Null pointer 2706.

In a case where the result of S7136 is N, that is, a case in which the acquired chunk pointer 2705 is not the Null pointer 2706, the fine-grained de-duplication control part 2420 moves the processing to the above-described S7135.

In a case where the result of S7136 is Y, that is, a case in which the acquired chunk pointer 2705 is the Null pointer 2706, the fine-grained de-duplication control part 2420 ends this flow.

The preceding is the chunk determination process.

According to the fine-grained de-duplication process, it is possible to compare data in units of chunks, and to eliminate a chunk, which is duplicated with a chunk written to the LU2 in the past, from the chunks stored in the LUT.

### Restore Control Process

A restore control process by the restore control part 2450 will be explained below.

The restore control part 2450 executes restore control processing in accordance with a restore control processing instruction from the backup server 300. The restore control process restores a specified backup in the LU2 to the LU1.

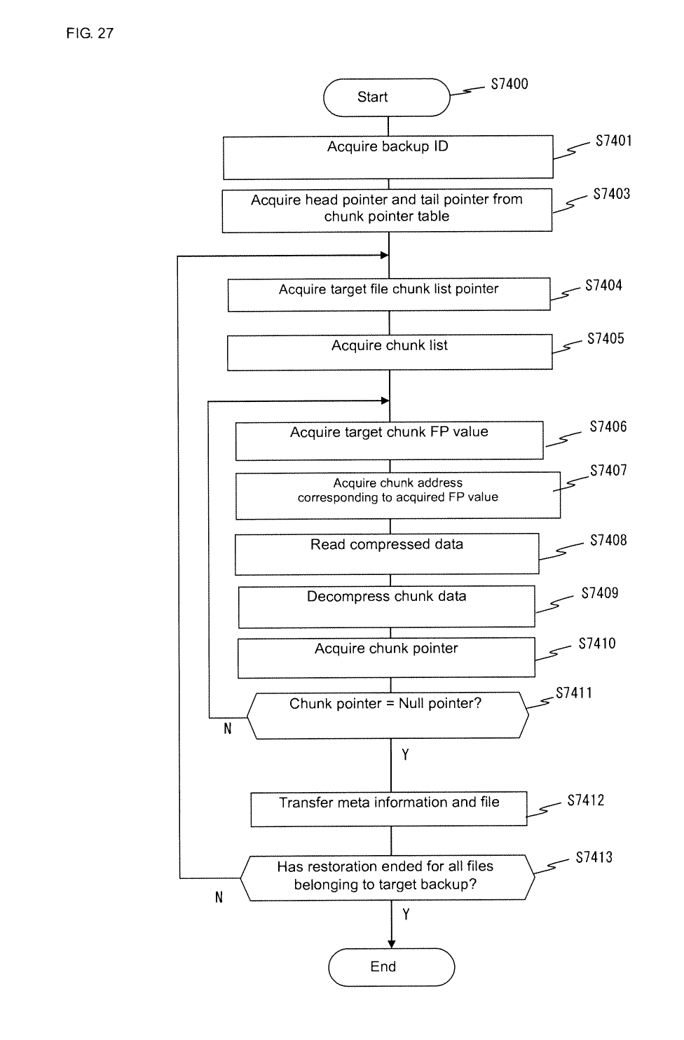

FIG. 27 shows a restore control process. In S7400, the restore control part 2450 starts the restore control process upon receiving a restore control processing instruction from the backup application 3400 of the backup server 300. The restore control processing instruction specifies a target backup. The target backup, for example, is shown in accordance with a backup ID.

Next, in S7401, the restore control part 2450 acquires the backup ID of the target backup. Next, in S7402, the restore control part 2450 acquires the address range for the file information 2702 belonging to the target backup by reading the head pointer 2542 and the tail pointer 2543 corresponding to the backup ID 2541 of the target backup from the backup management information 2701 of the chunk pointer table 2540 in the LU2.

Next, in S7404, the restore control part 2450 acquires one piece of file information 2702 from the acquired address range, treats this file as the target file, and acquires the target-file chunk list pointer 2545. Next, in S7405, the restore control part 2450 acquires the chunk list 2703 being pointed to by the acquired chunk list pointer 2545.

Next, in S7406, the restore control part 2450 treats the next chunk as the target chunk, acquires the target-chunk chunk node 2547 from the acquired chunk list 2703, and acquires the FP value 2548 from this chunk node 2547. Next, in S7407, the restore control part 2450 acquires the chunk address 2555 corresponding to the acquired FP value 2548 from the fine-grained de-duplication management table 2550. Next, in S7408, the restore control part 2450 reads the target-chunk compressed data 820 from the acquired chunk address 2555. Next, in S7409, the restore control part 2450 restores the file by decompressing the read data. Next, in S7410, the restore control part 2450 acquires the chunk pointer 2705 in the acquired chunk node 2547. Next, in S7411, the restore control part 2450 determines whether or not the acquired chunk pointer 2705 is a Null pointer.

In a case where the result of S7411 is N, that is, a case in which the acquired chunk pointer 2705 is not a Null pointer, the restore control part 2450 moves the processing to the above-described S7406.

In a case where the result of S7411 is Y, that is, a case in which the acquired chunk pointer 2705 is a Null pointer, the restore control part 2450 advances the processing to S7412. Next, in S7412, the restore control part 2450 acquires the meta pointer 2544 from the target-file file information 2702, acquires the meta information 2546 pointed to by the meta pointer 2544, and transfers the restored file to the LU1 of the storage apparatus 100 by transferring the acquired meta information and the restored file to the backup server 300. Next, in S7413, the restore control part 2450 determines whether or not the restorations for all the files belonging to the target backup have ended. In a case where the acquired file information 2702 has reached the read tail pointer 2543 here, the restore control part 2450 determines that the restorations of all the files belonging to the target backup have ended.

In a case where the result of S7411 is N, that is, a case in which the restorations for all the files belonging to the target backup have not ended, the restore control part 2450 moves the processing to the above-described S7404.

In a case where the result of S7411 is Y, that is, a case in which the restorations for all the files belonging to the target backup have ended, the restore control part 2450 ends this flow.

The preceding is the restore control process.

According to the restore control process, it is possible to restore a file, which has been deduplicated in accordance with the coarse-grained de-duplication process and the fine-grained de-duplication process and stored in the LU2 to the LU1 for each generation. Furthermore, the restore control part 2450 is able to acquire the meta information 2546 and the FP value 2548 of a file belonging to a target backup by using the chunk pointer table 2540. The restore control part 2450 can also acquire at high speed the chunk address 2555 corresponding to the FP value 2548 and the compressed data 820 corresponding to the chunk address 2555 by using the fine-grained de-duplication management table 2550.

The storage apparatus 200 of the example carries out in-line de-duplication processing for a file having a file size, which is equal to or smaller than a file size threshold, but does not carry out in-line de-duplication processing for a file having a file size, which is larger than the file size threshold. This makes it possible to reduce the impact of the in-line de-duplication process on access performance.

The storage apparatus 200 also does not carry out in-line de-duplication processing for a file having a preconfigured file format. This makes it possible to carry out in-line de-duplication processing only for a file for which in-line de-duplication processing is apt to be effective, and to reduce the impact of in-line de-duplication processing on access performance.

The storage apparatus 200 may also treat a fixed size data hash from the head of a file as a key, treat a data hash, which has been segmented from the file for each fixed size, as a value, and compare the hashes using a key-value. This makes it possible to compare the data both efficiently and accurately.

According to the example, it is possible to realize high execution efficiency and capacity reduction efficiency at low cost by performing in-line de-duplication processing prior to post-process de-duplication processing. It is also possible to reduce the amount of writing to a temporary storage area each time backup generations overlap.

In accordance with configuring an inhibit threshold table 2570, it is possible to change the allocation of the in-line de-duplication process and the post-process de-duplication process, and to adapt the storage system 10 to changing user requests.

According to the example, it is also possible to apply a low-cost, albeit performance overhead-prone virtual pool (Thin Provisioning, AST: Autonomic Storage Tiering, and so forth) to the storage apparatuses 100 and 200, and to reduce the costs of capacity design and capacity configuration management.

Furthermore, in the coarse-grained de-duplication process, the unit for calculating the FP value need not be the chunk. For example, the coarse-grained de-duplication control part 2410 partitions a file into multiple pieces of partial data, and calculates a partial data FP value. At this time, each piece of partial data is a part of a prescribed size from the head of the file.

The technology explained in the example above can be expressed as follows.

### (Wording 1)

A storage apparatus, comprising:

a storage device which comprises a temporary storage area and a transfer-destination storage area; and

a controller which is coupled to the above-mentioned storage device,

wherein the controller receives multiple files, and in accordance with performing in-line de-duplication processing under a prescribed condition, detects from among the above-mentioned multiple files a file which is duplicated with a file received in the past, stores a file other than the above-mentioned detected file of the above-mentioned multiple files in the above-mentioned temporary storage area, and partitions the above-mentioned stored file into multiple chunks, and in accordance with performing post-process de-duplication processing, detects from among the above-mentioned multiple chunks a chunk which is duplicated with a chunk received in the past, and stores a chunk other than the above-mentioned detected chunk of the above-mentioned multiple chunks in the above-mentioned transfer-destination storage area.

### (Wording 2)

A storage control method, comprising:

receiving multiple files;

in accordance with performing in-line de-duplication processing under a prescribed condition, detecting from among the above-mentioned multiple files a file which is duplicated with a file received in the past, and storing a file other than the above-mentioned detected file of the above-mentioned multiple files in a temporary storage area;

partitioning the above-mentioned stored file into multiple chunks; and

in accordance with performing post-process de-duplication processing, detecting from among the above-mentioned multiple chunks a chunk which is duplicated with a chunk received in the past, and storing a chunk other than the above-mentioned detected chunk of the above-mentioned multiple chunks in a transfer-destination storage area.

### (Wording 3)

A computer-readable medium for storing a program which causes a computer to execute the process comprising:

receiving multiple files;

in accordance with performing in-line de-duplication processing under a prescribed condition, detecting from among the above-mentioned multiple files a file which is duplicated with a file received in the past, and storing a file other than the above-mentioned detected file of the above-mentioned multiple files in a temporary storage area;

partitioning the above-mentioned stored file into multiple chunks; and

in accordance with performing post-process de-duplication processing, detecting from among the above-mentioned multiple chunks a chunk which is duplicated with a chunk received in the past, and storing a chunk other than the above-mentioned detected chunk of the above-mentioned multiple chunks in a transfer-destination storage area.

### REFERENCE SIGNS LIST

10 Storage system
100 Storage apparatus
120 Shared memory
130 Cache memory
140 Data transfer part
150 Storage device
160 Communication interface
170 Device interface
180 Controller
200 Storage apparatus
300 Backup server
400 Management computer
2300 Drive control part
2410 Coarse-grained de-duplication control part
2420 Fine-grained de-duplication control part
2430 Schedule control part
2440 Backup control part
2450 Restore control part
2460 Inhibit threshold control part
2510 Meta information
2520 File pointer table
2530 FP table for coarse-grained determination
2540 Chunk pointer table
2550 Fine-grained de-duplication management table
2560 Status management table
2570 Inhibit threshold table

1. A storage apparatus, comprising:
a storage device which comprises a temporary storage area and a transfer-destination storage area; and
a controller which is coupled to the storage device,
wherein the controller receives multiple files, and by performing in-line de-duplication processing under a prescribed condition, detects from among the multiple files a file which is duplicated with a file received in the past, stores in the temporary storage area a file other than the detected file of the multiple files, and partitions the stored file into multiple chunks, and by performing post-process de-duplication processing, detects from among the multiple chunks a chunk which is duplicated with a chunk received in the past, and stores in the transfer-destination storage area a chunk other than the detected chunk of the multiple chunks.

2. The storage apparatus according to claim 1, wherein the controller identifies from among the multiple files a file having a file size which exceeds a file size threshold, and stores the identified file in the temporary storage area, and by performing the in-line de-duplication processing, detects from among files other than the identified file of the multiple files a file which is duplicated with a file received in the past.

3. The storage apparatus according to claim 2, wherein the controller changes the file size threshold based on an amount of I/O of the controller.

4. The storage apparatus according to claim 1, wherein the controller identifies from among the multiple files a file comprising a preconfigured file format and stores the identified file in the temporary storage area, and by performing the in-line de-duplication processing, detects from among files other than the identified file of the multiple files a file which is duplicated with a file received in the past.

5. The storage apparatus according to claim 4, wherein the controller identifies a file having a preconfigured file format from among the multiple files by detecting a file format based on a header of each of the multiple files.

6. The storage apparatus according to claim 1, wherein the controller determines whether or not the in-line de-duplication processing is performed based on the amount of I/O of the controller.

7. The storage apparatus according to claim 6, wherein the controller does not perform the in-line de-duplication processing in a case where the amount of I/O of the controller exceeds a preconfigured threshold.

8. The storage apparatus according to claim 1, wherein
the controller, in a case where a first file is stored in the temporary storage area by the in-line de-duplication processing, calculates a first key which is a key based on a hash value of a partial data from the head of the first file up to a prescribed size, and stores the first key in the transfer-destination storage area, and
the controller, in a case where a second file has been received after the first file, calculates a second key which is a key based on a hash value of a partial data from the head of the second file up to the prescribed size, and determines whether or not the second file is duplicated with the first file based on comparison of the first key with the second key.

9. The storage apparatus according to claim 8, wherein
the controller calculates a value as a first value which is a hash value of partial data of each of the prescribed sizes of the first file, associates the first value with the first key, and stores the first value in the transfer-destination storage area, and
the controller, in a case where the first key matches the second key, calculates a value as a second value which is a hash value of partial data of each of the prescribed sizes of the second file, compares the first value with the second value, and in a case where the first value matches the second value, determines that the second file is duplicated with the second file.

10. The storage apparatus according to claim 9, wherein the controller calculates a number of pieces of partial data for each prescribed size of a file targeted for the in-line de-duplication processing, calculates a hash value of a partial data from the head of the targeted file up to a prescribed size, and calculates a key which comprises the calculated number and the calculated hash value.

11. The storage apparatus according to claim 1, wherein
the controller, in a case where a first chunk is stored in the transfer-destination storage area by performing the post-process de-duplication processing, calculates a first hash value which is the hash value of the first chunk, and stores the first hash value in the transfer-destination storage area, and
the controller, in a case where the second chunk has been received after the first chunk, calculates a second hash value which is the hash value of the second chunk, compares the second hash value with the first hash value, and in a case where the second hash value matches the first hash value, determines that the second chunk is duplicated with the first chunk.

12. The storage apparatus according to claim 11, wherein the controller associates the first hash value with the location of the first chunk in the transfer-destination storage area, and stores the association in the transfer-destination storage area.

13. A storage control method, comprising:
receiving multiple files;
by performing in-line de-duplication processing under a prescribed condition, detecting from among the multiple files a file which is duplicated with a file received in the past, and storing in a temporary storage area a file other than the detected file of the multiple files;
partitioning the stored file into multiple chunks; and
by performing post-process de-duplication processing, detecting from among the multiple chunks a chunk which is duplicated with a chunk received in the past, and storing in a transfer-destination storage area a chunk other than the detected chunk of the multiple chunks.
